(19) United States
(12) Patent Application Publication
(10) Pub. No.: US 2023/0040968 A1
(43) Pub. Date: Feb. 9, 2023

(54) SEARCH TOOL FOR LOCAL INFORMATION

(71) Applicant: NearMe Entertainment, Inc., Las Vegas, NV (US)

(72) Inventors: George Meyer, Las Vegas, NV (US); Joe Keely, Denver, CO (US); John Burgarin, Tomahawk, WI (US); Roland Ashley Hughes, Las Vegas, NV (US)

(21) Appl. No.: 17/814,093

(22) Filed: Jul. 21, 2022

Related U.S. Application Data
(60) Provisional application No. 63/224,218, filed on Jul. 21, 2021.
(60) Provisional application No. 63/265,560, filed on Dec. 16, 2021.

(51) Int. Cl. G06F 16/9537; G06F 16/9538

(52) U.S. Cl. CPC G06F 16/9537; G06F 16/9538

(57) ABSTRACT

A tool and associated functionality are described for efficiently obtaining information regarding local goods and services as well as making associated arrangements. The tool includes a system (100) for accessing and using a Wi-Fi hotspot (102). The hotspot (102) allows a user device (104) to access portals (116) of a network (114), such as the Internet, via a gateway (106) of the hotspot (102). The tool then monitors (204) the operation of the user device (104) to identify a condition that indicates a captive portal issue. In response, the tool transmits (208) a trip message to the gateway (106). The user device (104) then receives a challenge from the gateway. Once the challenge has been satisfied, the tool establishes a connection to a network portal (116). The tool may access the portal (116) to download local information such as search results, mapping information, or the like.

### CROSS-REFERENCE TO RELATED APPLICATION

This application claims benefit of U.S. Provisional Patent Application No. 63/224,218, entitled, “SEARCH TOOL FOR LOCAL INFORMATION,” filed Jul. 21, 2021, and U.S. Provisional Patent Application No. 63/265,560, entitled, “SEARCH TOOL FOR LOCAL INFORMATION,” filed Dec. 16, 2021, the contents of which are hereby incorporated by reference in their entirety.

### FIELD OF THE INVENTION

The present invention relates generally to network-based search tools and, in particular, to a network-based tool for accessing information about local sources of goods and services.

### BACKGROUND OF THE INVENTION

Residents and visitors of cities or other locations spend considerable time and effort obtaining local information, for example, concerning local restaurants, resorts, events, activities, and other goods or services. In many cases this involves a series of searches using network-based tools. The case of a visitor making evening plans (for the same day or in advance) is illustrative. The visitor may first conduct a search to identify local events on the evening of interest. It may be difficult to construct an appropriate search if the visitor is unfamiliar with the destination. For example, the visitor may not be able to efficiently construct a search that is appropriately limited with respect to location or that encompasses the types of activities that are available in the locality that are of interest.

In this regard, a variety of websites specialize in locating upcoming events or activities for a city or other locality. However, those sites often rely on the user to enter a search, for example, by selecting a magnifying glass icon, or provide some pull-down textual lists of filter categories. The magnifying glass icon is very common in this regard. Typically, the user selects the magnifying glass icon and then enters a text search term or terms. This works for users who have a well-defined idea of what they want to do, but not as well for users who don't know what they want to do, don't know what is available, or simply prefer to browse without well-defined preconceptions.

However, assuming that the visitor can eventually construct an appropriate search, and that the visitor can access and use an available network access point such as a Wi-Fi hotspot, the visitor may identify, for example, a show of interest on the date of interest. The visitor may then desire to obtain tickets for the show and make reservations for a late dinner after the show at a nearby restaurant. If the original search results did not include a link to purchase tickets, the visitor may then need to identify a ticket broker and determine if tickets are available. Then the visitor may start working on dinner reservations. For example, if the visitor has a particular type of food in mind, e.g., Japanese food in a fine dining environment, the visitor may construct another search. If the search results are presented on a map, the visitor might be able to match the restaurant search results map to a map showing the location of the show. The visitor may then visit websites of the restaurants of interest to determine if they are open on the date and time of interest and to inquire about reservations. Finally, the visitor may conduct yet another search to obtain walking or driving directions, e.g., from the visitor's hotel to the venue of the show.

It is a great convenience of modern networks that the visitor can potentially obtain this information. However, obtaining such information and making arrangements continues to be burdensome as described above.

### SUMMARY OF THE INVENTION

The present invention is directed to a tool and associated functionality for efficiently obtaining information regarding local goods and services as well as making associated arrangements. The invention facilitates access to and use of wireless network access points and designation of the location or geography of interest (the locality). In addition, the invention enables users to readily identify categories of goods and services of interest and to easily access a rich set of features relating to: filtering search results to the user's interests; obtaining information about hours of operation, offers, and events related to the source of goods and services; making arrangements related to the source such as arranging transportation, making reservations, or purchasing tickets; and obtaining directions to the source of goods and services, among other things. This information can be provided within a single search environment based on a single search and use of dynamic features of the search results. As a result, residents of and visitors to a given locality can efficiently access local information, even without detailed knowledge of the locality or prior knowledge of the goods and services available.

In accordance with one aspect of the present invention, a network-based tool and associated functionality (“system”) are provided for searching local information based on certain visual category selectors. The system involves establishing a data collection of local information concerning sources of goods and services within a defined geography such as a metropolitan area or other locality. Subsets of the local information are defined based on categories of goods and services. For example, the categories may relate to local restaurants, resorts, events, activities or any other goods or services. The data collection is structured to enable access to each of the subsets of the local information based on identification of one or more of the categories of goods and services. A network-based tool is then activated for allowing users to search the data collection and, in connection with the network-based tool, a graphical user interface screen is provided that includes a number of visual category selectors where each of the selectors is configured to allow user selection of a corresponding one of the categories of goods and services. In connection with each of the visual category selectors, an image is displayed that represents the corresponding category of goods and services. For example, the image may be obtained from a website of one source of the specified types of goods and services, e.g., a picture of dune buggies may be used to identify the category “activities” or a subcategory of “wild and crazy.”

In accordance with a further aspect of the present invention, a local information search system includes dynamic, look-ahead filters to facilitate refinement of search results. The system generally includes a network-based tool for accessing local information as discussed above. In connection with the tool, a number of filters are provided for filtering the results of a search, where each of the filters is associated with one or more defined attributes such the content of the search results is modified in relation to a presence or absence of the defined attributes with respect to one or more items of the search results. For example, if a user obtains search results identifying Japanese restaurants within the locality of interest, the network-based tool may include filters allowing the results to be filtered with respect to various attributes such as fine dining, celebrity chef, new, outdoor patio, etc. A graphical user interface screen may be provided including a first portion for allowing the user to select available filters and a second portion for displaying the results of the search.

The graphical user interface screen may be implemented in connection with the tool to include at least one dynamic, look-ahead filter, where selection of the dynamic, look-ahead filter in the first portion of the screen results in modification of search results displayed in a second portion of the screen. For example, as noted above, the first portion may include a number of graphical elements corresponding to different filters. When a first filter is selected, the appearance of graphical elements corresponding to other filters may be modified, for example, to show that certain filters are no longer available (e.g., because there are no reach results that satisfy the corresponding filters in combination with other filters already selected) and/or to indicate a number of search items satisfying the corresponding filter in combination with other filters already selected. Moreover, upon selection of a filter in the first portion of the graphical user interface screen, the results in the second portion of the screen may be updated in real time. For example, certain search result items may be eliminated in real time because they do not satisfy the constraints of the selected filter or the results may be highlighted, re-ordered, or otherwise modified to emphasize certain results in relation to the selected filter.

In accordance with a still further aspect of the present invention, a local information system provides search results with integrated, interactive weekly calendars. The system may include a network-based tool for searching local information as described above. In connection with the network-based tool, a graphical user interface screen may be provided for displaying results of his search where the results include a number of graphical objects, each of the graphical objects including information concerning a source of goods and services responsive to the search. In connection with at least one of the graphical objects, a dynamic calendar is provided including display elements corresponding to multiple days, where the user can select one of the display elements to obtain, on the graphical user interface page, information specific to the selected day. For example, upon selecting one of the display elements, the graphical user interface screen may display hours of operation for the selected day or events and offers for the selected day. In this manner, the user can obtain information spanning, for example, a week without having to repeat a search.

In accordance with another aspect of the present invention, the search results of a local information system may include status information such as “opening soon” or “closing soon” in text and/or graphical form. As discussed above, a network-based tool may provide a graphical user interface screen displaying results of a search including a number of graphical objects, where each of the graphical objects includes information concerning a source of goods and services responsive to the search. At least one of the graphical objects may include a dynamic display element that changes based on temporal proximity to one of an opening time and a closing time of a source of goods and services. For example, in connection with a display of operating hours, textual information may be provided indicating that the source opens soon or closes soon. Additionally, or alternatively, in connection with a map showing the locations of search results, an icon or other indicator for the source may be color-coded or otherwise modified to indicate that the source is opening soon or closing soon. The decision regarding whether the source is opening soon or closing soon may be determined in relation to a static threshold such as a closing or opening time that is within a predetermined threshold (e.g., one hour) of the current time, or may be dynamically determined, e.g., in relation to a travel time or distance to reach the source of goods or services or other factors.

In one implementation, the local information system generally employs three filters that are turned on by default; “open now,” “opens later,” and “closed.” For certain sections of the system, these may be replaced by subject matter specific filters such as, in the case of a Shows and Events section, “today's shows,” “coming soon,” and “show all.” The system can automatically show status information such as “closing soon” if the current time is within a predetermined threshold (e.g., an hour) of the closing time for the business. The system can use colors to indicate the status on both the list and map views with outlines/shading and map pin colors (e.g., green for open, blue for opening later, orange for closing soon, and red for currently closed).

In accordance with yet another aspect of the present invention, a local information system may provide facility information. In many cases, a restaurant, retail outlet or other source of goods and services may be located within a larger resort, mall, or other facility. In such cases, it is useful to provide not only information concerning the source of goods or services but also facility information such as mapping information regarding sources within the facility. Accordingly, a network-based tool may provide a first graphical user interface including directions to a facility where the first source is located and a second graphical user interface including facility information. For example, the second graphical user interface may provide directions to the source within the facility or a map of the facility.

In accordance with a further aspect of the present invention, a local information system can provide promotional information based on a known or inferred destination of a user. The local information system of the present invention may include a network-based tool that implements a variety of features relating to local sources of goods and services. For example, the tool may provide directions to a source of goods and services, the tool may be used to arrange transportation to a source of goods and services, or the tool may be used to purchase tickets or make reservations for a source of goods or services, among other things. In any of these cases, the tool may know or infer a destination of the user. In this regard, the system may involve monitoring operation of the network-based tool to obtain an indication that the user intends to visit a first source of goods and services and delivering to the user, via the network-based tool, promotional information related to the first source of goods and services. The promotional information may be, for example, advertising concerning goods and services available at the first source of goods and services or a related or proximate source of goods or services, coupons or other incentives concerning the first source of goods or services or a related/proximate source, or service information such as parking information, available services, or the like.

In accordance with another aspect of the present invention, a network-based tool and associated functionality is operative for overcoming the captive portal problem. In many cases, when a user attempts to use an application via a wireless public network access point such as a Wi-Fi access point or gateway, the application will not function properly. In some cases, this is because the application did not trigger a network registration or validation process. Accordingly, when the application attempts to download information from a network portal via the gateway, the application will be unable to download the information. This is particularly problematic when a user moves between hotspots, e.g., in a resort area, or where hotspots periodically require sign-ins, e.g., after passage of a certain amount of time or after a daily sign-in expires. Moreover, in many cases, it is difficult for the user to identify what is causing the problem or to access the registration or validation screen.

The inventive tool involves using a wireless device to access a wireless public network access point and activate a network-based tool. The wireless device can then be operated free from user input to: monitor operation of the network-based tool to identify a gateway failure involving failure to properly interact with a network platform via the public network access point; in response to the identified gateway failure, control the wireless device to generate and transmit, via the wireless public network access point, a trigger to the gateway; and receive a challenge from the gateway responsive to the trigger. For example, the challenge may require the user or the device to input registration or validation information. The system further involves operating the network-based tool to access the network platform via the wireless public network access point to execute functionality of the network-based tool. As discussed below, the network-based tool may include, for example, functionality for accessing local information concerning goods and services available in the locality.

### BRIEF DESCRIPTION OF THE DRAWINGS

For a more complete understanding of the present invention, and further advantages thereof, reference is now made to the following detailed description, taken in conjunction with the drawings, in which:

FIG. 1 is a schematic diagram of a system for using a wireless network access point in accordance with the present invention;

FIG. 2 is a flowchart illustrating a process for using a wireless network access point in accordance with the present invention;

FIG. 3 is a schematic diagram of a local information system in accordance with the present invention;

FIGS. 4-45, 47, 49-58, and 65-66 show graphical user interface screens of a local information system in accordance with the present invention;

FIG. 46 shows icons used for features and warnings in the restaurants category in accordance with the present invention;

FIG. 48 shows a data model for sending data from a local information platform to logic running on user devices in accordance with the present invention;

FIGS. 59A-61E are user interface screens showing functionality related to accessing relevant streaming content in accordance with the present invention;

FIG. 62 is a schematic diagram of a system for accessing relevant streaming content in accordance with the present invention;

FIG. 63 is a flow chart summarizing functionality for accessing relevant streaming content in accordance with the present invention; and

FIG. 64 is a flow chart illustrating a process for reconfiguring dynamic or interactive elements of a user interface screen in accordance with the present invention.

### DETAILED DESCRIPTION

The present invention is directed to a system for facilitating access to and use of a wireless network access point, as well as a local information system for providing efficient access to rich information and features concerning local goods and services. In the following description, the invention as set forth in the context of specific examples relating to accessing a Wi-Fi hotspot using a mobile device to obtain information about local goods and services. However, the invention is not limited to this context. Accordingly, the following description should be understood as illustrative and not by way of limitation.

In the following description, a network-based tool is first described in detail by reference to a number of graphical user interface screens. Thereafter, a system for accessing and using a Wi-Fi hotspot is described. Finally, the hardware and network environment of the invention is described.

Various functionality of the local information system will now be described in relation to exemplary graphical user interface screens that may be rendered on a user device. The graphical user interface screens shown below will be recognized as displays that may be rendered in connection with a mobile telephone or tablet computer and, indeed, this is a particularly advantageous implementation of the present invention to provide local information to users who are away from their homes or offices. However, it will be appreciated that the system is also adapted for use on laptop computers, desktop computers, or other data terminals and that the user interface screens may be specifically adapted for those environments.

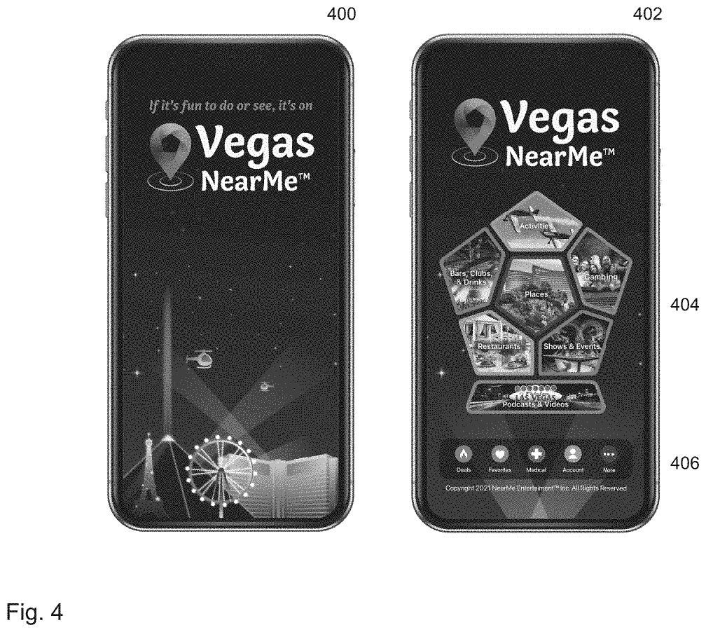

FIG. 4 illustrates two graphical user interface screens 400 and 402 that may be displayed in connection with a local information system. Screen 400 illustrates a splash screen that may be displayed upon launching of the local information tool. In this case, the tool provides information regarding local goods and services in the Las Vegas, Nev. metropolitan area. After this splash screen 400 is displayed, the tool may display a homepage 402. By way of example, the homepage 402 may include a number of graphical elements 404 that can be selected by a user to access high-level categories of local service information of interest as well as a number of service buttons 406 for accessing important or frequently used functions. In the illustrated example, the graphical elements 404 identify the categories of: activities; gambling; shows and events; restaurants; bars, clubs, and drinks; places; and podcasts and videos. Various ones of these will be described in more detail below. It will be appreciated that other categories may be provided and that different categories may be provided in different localities depending on the nature of the local business environment.

The illustrated buttons 406 include a deals button, a favorites button, a medical button, an account button, and a more button for allowing access to additional buttons. The deals button may identify feature deals for the present time in the locality of interest. The featured deals may be selected by an administrator, determined in relation to what is trending or popular, or individual sources of goods and services may pay a premium to have their deals featured. The favorites button may present a list of categories, screens, or specific sources of goods and services that are frequently accessed by the user of the device. The medical button may provide information regarding local medical services including emergency services. The account button provides a shortcut for the user to access and edit account information for an account of the local information system or other financial or loyalty program accounts of the user. A variety of other buttons may be accessed by clicking the more button.

The local information system can also offer coupons and other deals that can be designed and implemented in real-time or near real-time by businesses. These deals may be time-sensitive and/or location-aware. For example, the local information system may know the location and destination of, e.g., an Uber passenger, car driver, or walker. Such information may be learned or inferred from shared GPS information or if the individual made Uber arrangements or requested driving/walking instructions from the local information system or another system that allows access or shares information. In such cases, coupons or other deals may be pushed or made available to the individual based on the destination and time of arrival, e.g., upselling promotions. Deals may also be used to promote nearby or perhaps even competing businesses in certain implementations and circumstances.

One useful feature of the local information system is visual category selectors. The visual category selectors extend from high-level categories to subcategories and eventually to individual sources of goods and services. As noted above, the homepage 402 includes a number of graphical elements 404 identifying high-level categories of goods and services. As shown, each of these elements 404 includes a graphical image that immediately and positively identifies the categories. Thus, the “places” category includes an image of resorts, and the “gambling” category includes an image of gambling activities. This will assist users in quickly identifying categories of interest including users who may have a language or other communication barrier. The images employed may, for example, be selected from websites of sources of goods and services within that category. Such images may be selected by a system administrator, selected based on trends or popularity, or individual sources of goods and services may pay premium to have their image displayed in connection with the category. Alternatively, custom or stock images may be used.

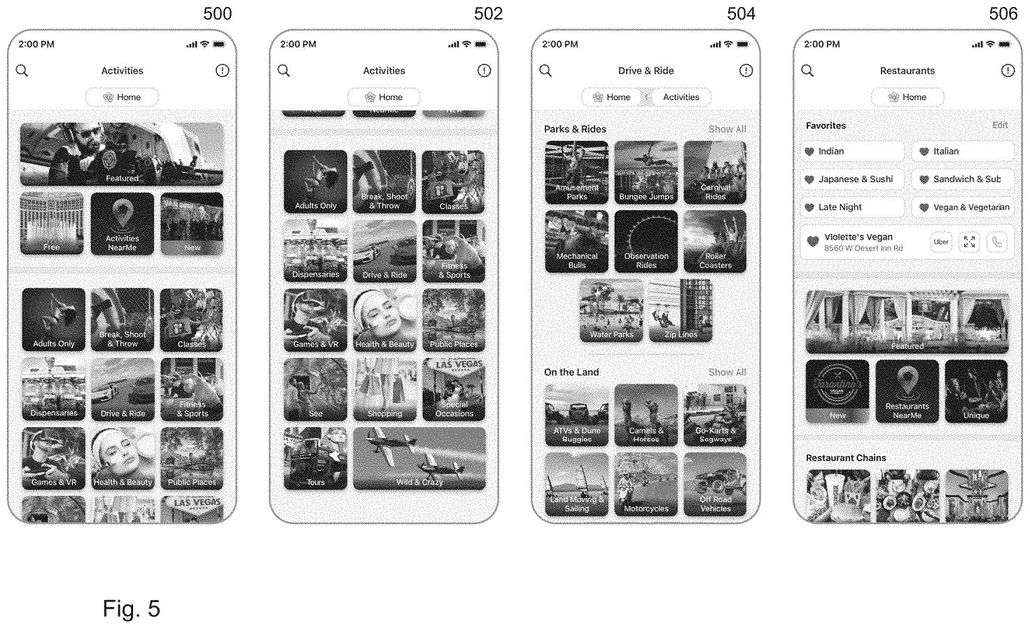

FIG. 5 shows additional examples of visual category selectors. The first screen 500 and second screen 502 of FIG. 5 shows a screen (top and bottom portions) that may be presented upon selecting the “activities” category. Within the “activities” category, the user is prompted, by way of additional visual category selectors, to enter a sub-category. In the illustrated example, these sub-categories include new activities, wild and crazy activities, drive and ride activities, beauty and health activities, and others. Again, each subcategory is associated with an image that immediately and positively depicts the nature of the subcategory and the images may be taken from websites of individual sources of goods and services within the associated sub-category. Screen 504 shows a user interface that may be presented in connection with selecting the drive and ride sub-category. Within this sub-category, the available activities may be further broken down into “parks and rides,” “in the sky,” and “on the land” (not all shown) activities and visual category selectors may be provided in each grouping.

Screen 506 shows further examples of visual category selectors. The screen 506 may be displayed upon selecting the category of “restaurants.” The screen 506 may display, among other things, favorites of the user, favorite cuisine categories of the user, general cuisine categories, and a variety of filters. In the illustrated example, Violette's Vegan is identified as a favorite of the user. In this manner, the user has convenient access to information about this favorite restaurant. The address, operating hours or closing time of the restaurant, and distance to the restaurant, among other things, may be displayed. In addition, buttons are provided to call the restaurant, to arrange for transportation to the restaurant, or to expand the restaurant information to fill the whole screen (and provide additional information). The “favorite cuisines” section provides convenient access to a subset of cuisine categories that have been identified as favorites by the user or are inferred to be favorites of the user based on prior usage history. The cuisines section of the screen allows a user to select categories of cuisine that are of interest. The filter section provides graphical elements that allow search results to be filtered based on various criteria such as new, unique, featured, etc. Again, the filter categories are associated with visual category selectors that immediately and positively identify the nature of the filter criteria.

Such filters allow a user to more specifically define the goods or services of interest. For example, a user may wish to employ filters in combination to limit the number of items returned in the search results and to identify the sources of goods and services of the greatest interest to the user. It will be appreciated, though, that it may be difficult for a user to anticipate how many filters, and in what combination, are likely to yield a manageable number of search results. The user may learn what works through trial and error, but this is not always efficient.

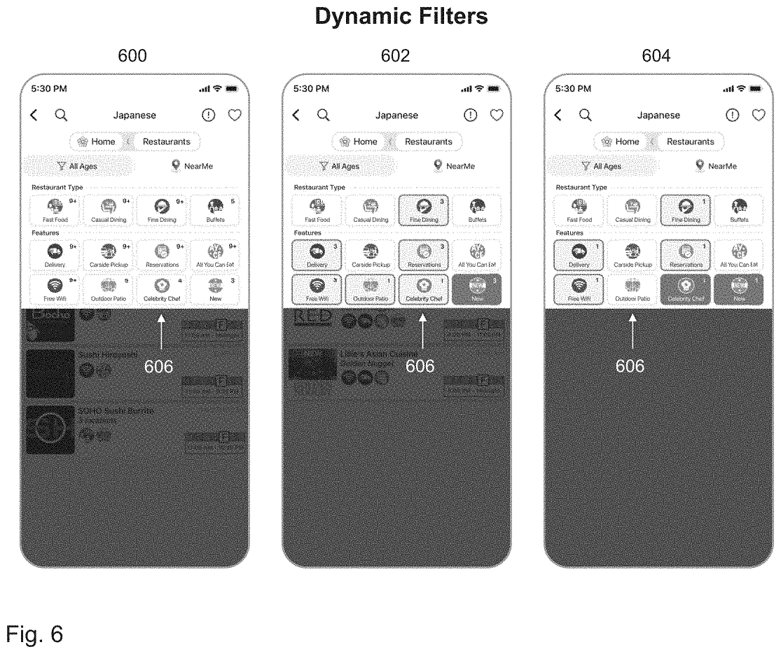

Accordingly, the system of the present invention may employ dynamic look-ahead filters. An example of this is shown in FIG. 6. Screen 600 shows a user interface that may be presented upon selection of the category “restaurants” followed by selection of the genre “Japanese.” The screen 600 reflects features that will be described below. First, though, the screen includes a section 606 that shows available filters that may be selected by the user. Examples include new, celebrity chef, fine dining, etc. The graphical element associated with each of these filters may include a number identifying the number of search result items, in this case restaurants, that satisfy the criteria of the filter. In the case of screen 600, none of the filters has yet been selected. The area below section 606 shows search result items, in this case, Japanese restaurants in the locality.

Screen 602 shows the same user interface after selection of the “new” filter. Upon selection of this filter, the user interface changes several ways. First, the appearance of the selected “new” filter changes to show that this filter has been selected. In this case, the graphical element associated with that filter is shaded. In addition, the appearance of the graphical elements associated with the other filters may change. Specifically, the appearance of these other elements changes to indicate which filters are still available. That is, some of the elements are highlighted, for example, by light shading or highlighting of the element borders, to indicate that there are Japanese restaurants that satisfy both the selected “new” filter as well as the remaining available filter. Moreover, a number may be provided in connection with the remaining available filters to indicate how many search result items satisfy the conditions of the previously selected filter and the available filter. For example, in the illustrated case, the number “3” is shown in the corner of the “fine dining” graphical element to indicate that there are three restaurants in the Las Vegas area that are deemed to be new and are further deemed to be fine dining restaurants. Other filters that do not have highlighted borders are thus identified as being unavailable indicating that there are no restaurants that satisfy the previously selected filter and also satisfy the unavailable filter. It will be noted that the area of the screen below section 606 has also been modified to include only the restaurants that satisfy the “new” filter.

Screen 604 shows the appearance of the user interface after the selection of two filters; in this case, the “new” and “celebrity chef” filters. As shown, fewer of the remaining filters are indicated as being available. In this specific example, it would be possible to select the delivery, free Wi-Fi, fine dining, and reservations filters, in combination with the already selected filters, each of which would yield one result. It will be observed that the search results area of the screen below section 606 indicates a single search result item. System structure for implementing such dynamic display elements is described in more detail below.

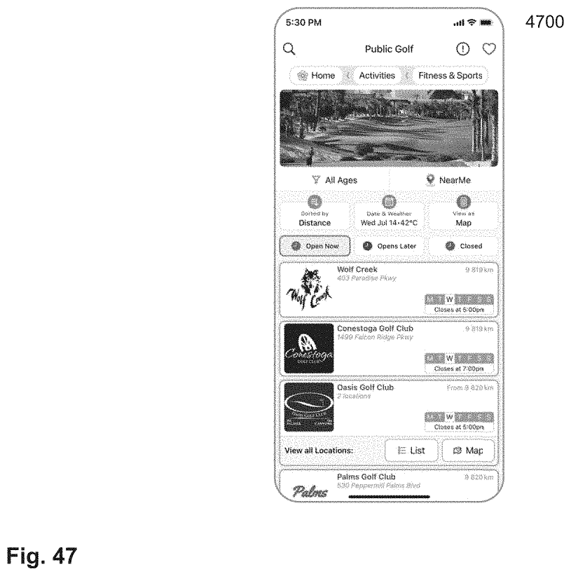

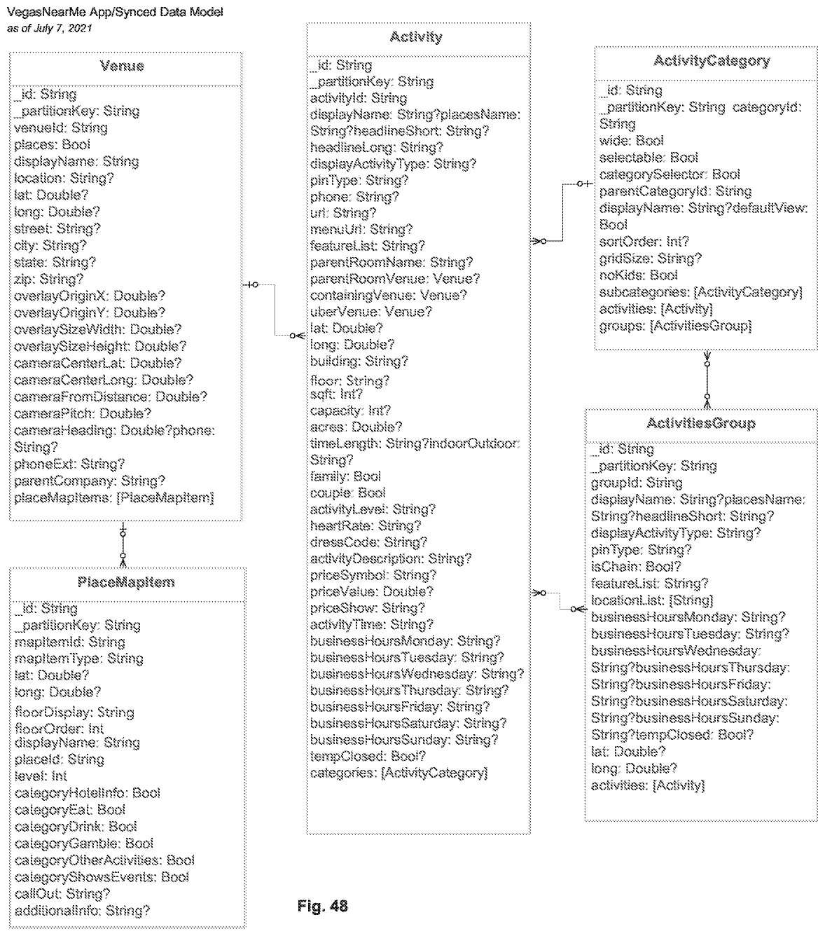

FIG. 6 illustrates some additional features. Near the top of the user interface of each screen is a pentagonal graphical element that allows the user to return to the home screen. Next to this graphical element is another element labeled “restaurants” that would allow the user to navigate to the restaurants category. Later, after the user has navigated, for example, to subcategories such as specific cuisines and a particular restaurant, the user can use the “restaurants” element to return to the restaurants category in a single click. Such a detailed navigation tree is also shown in FIG. 47. Specifically, the navigation tree may include a series of tabs showing multiple or all levels of categories and sub-categories navigated to get to the current page (or all parent, grandparent, etc., categories and subcategories regardless of the navigation path to the current page). For example, if the user is looking at a public golf courses page, the second row of the user interface screen may show the pentagrid with the “home” label on the left, the “activities” tab in the center, and the “fitness and sports” tab on the right. This provides a powerful and intuitive navigation feature for users to jump to any level in the category hierarchy to visit or re-visit options with minimal clicks or taps. Such navigation trees may be provided throughout the local information system.

Referring again to FIG. 6, near the upper left corner of the screen 600 is a magnifying glass icon that allows the user to manually enter a search. The screen may also include a graphical element that allows the user to order the search results by closest to farthest or other criteria as well as buttons that allow the user to turn filters on or off, indicate the date of interest, provide weather information, and allow the user to limit results to those “near me.” Further, a filters button may allow the user to turn on or turn off predefined filters, for example, relating to the age of the user, user preferences, or the like. As discussed in more detail below, a date button may default to the current date but may be changed to a different date indicated in relation to a calendar. For example, a user may be interested in getting restaurant information or making reservations for a future date.

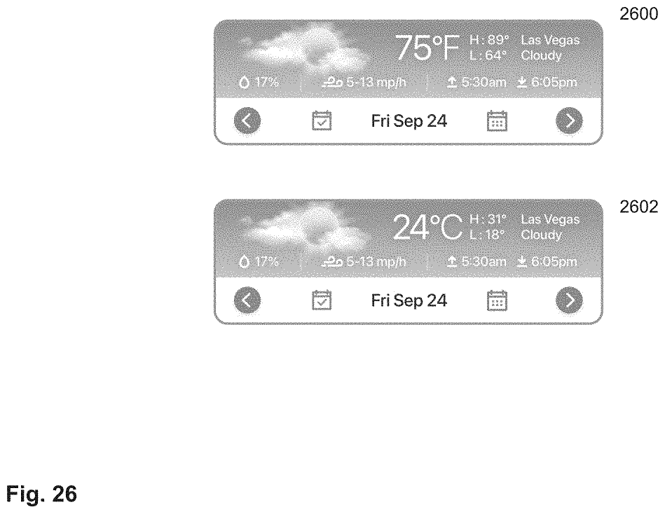

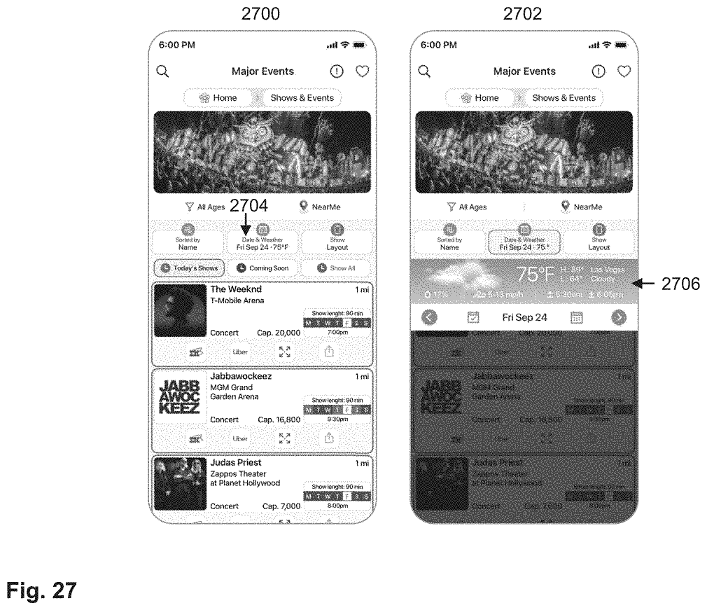

A weather panel (described in more detail below, see, e.g., FIGS. 26-27) may indicate weather information such as precipitation and temperature. The weather information may automatically change to predicted weather when the date selected on the date button is changed. That is, the weather information will automatically change between current and forecasted or historical weather or vice versa as needed. For example, on the current day, the system may show current, real-time temperature and weather conditions (including wind speed) and the current forecast temperature ranges for near-term future dates. For more distant future dates, for example, if the user is planning a trip months in advance, the system may provide historical or average weather data for the date under consideration. The system can also show sunrise and sunset times for the current, near-future, or more distant future, which is useful for planning certain outdoor activities such as golf or hiking. The user may explicitly enter the date for the weather information (e.g., current, or future date) or the date may be inferred, e.g., current by default but changing to a future date if the user is making reservations for a future date.

Finally, the “near me” button may limit search results to search result items that are within a default or specified distance of the current or designated location of the user. The current location may be obtained from the location services of the user device. Alternatively, a user may specify a particular location, such as the location of a hotel where the user is staying, as the designated location. If this is selected, then search results and directions will be initiated in relation to the designated location. Such filters can be intelligently implemented. For example, a user may search for Italian restaurants and initially see results sorted by distance from the user (or designated location). If the user, however, then selects the “restaurants near me” category, then the user may see all restaurants of all different types and cuisines that are sufficiently close. Similarly, if the user selects shows and events near me, then all shows and events sufficiently close to the user may be shown. This can be used in conjunction with a designated location to, for example, see the restaurants near a resort that the user plans to visit in the future. Alternatively, such filters may be combined, for example, to see the closest Italian restaurants or all nearby restaurants with Italian restaurants listed first or otherwise prioritized.

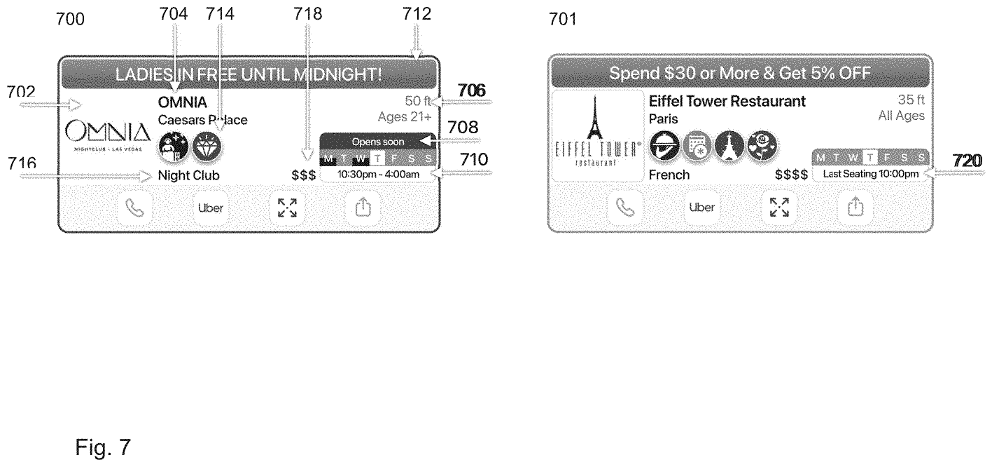

The area of the user interface below the filter section 606 includes the search results on an item by item basis with a variety of information for each item. FIG. 7 shows a close-up view of one of these search result items 700. In the illustrated example, the item 700 includes a graphical identifier and/or a logo 702 for the source of goods or services, a textual identifier 704 of the source and location, the distance 706 of the source of goods or services from the current or designated location of the user, any identification 708 of an upcoming change in status, an interactive, integrated week calendar 710 for the source of goods or services, a panel 712 for providing descriptive or promotional information for the source of goods or services, icons 714 identifying various attributes or features of the night club that may tie into filter options (e.g., “Nightclub,” “Unique,” etc.), and a panel 716 that lists the services category. The graphical identifier 702 may include a logo or image identifying the source. The graphical identifier 702 may be obtained from a website of the source or otherwise provided by the source. The textual identifier 704 includes information sufficient to identify the source such as the name of the source and a street and/or city location of the source. The distance 706 of the source from the current or designated location of the user may be provided, for example, in terms of distance or travel time. In the case of distance, the distance may be calculated in linear point-to-point fashion or driving distance measured in relation to the most direct or fastest route via the driving map topology.

The identification 708 may include any information related to the status of the source such as closed today, opens at a certain time, opens soon, or closes soon. In relation to opening soon or closing soon, the warning may be triggered by comparing the current time to the scheduled opening time or scheduled closing time. The determination may be based on a static threshold such as a one-hour threshold or may be determined dynamically in relation to the distance or expected travel time to the source of goods or services. As discussed below, such opening soon or closing soon information may also be reflected on a map of search results. In particular, icons for particular sources of goods and services may be color-coded or otherwise configured to identify sources that are opening soon or closing soon, among other things. Such configuration may be based on the same determination used for the identification 708.

The operating hours may include information beyond opening time and closing time. For example, certain businesses may have operating intervals. Thus, a buffet restaurant may have a breakfast/brunch interval, a lunch interval, and a dinner interval. Similarly, some restaurants may have different menus or cuisine styles available at different times. Thus, a Japanese restaurant may have Sushi available throughout its operating hours but only have Teppanyaki available for a shorter time period. This problem is not limited to restaurants but extends to other activities where customers need to arrive with sufficient time to do the activity. Such information may be indicated in the operating hours. For example, instead of listing operating hours in the bottom panel of the calendar 710, that panel may simply say “tap to see times.” Then a screen can be presented that provides more complete information than operating hours.

Similarly, some businesses may have a last start time that is different from the closing time. For example, a restaurant may officially close at 1 AM but may have its last seating at, for example, 11:00 PM. What many users really care most about is the “last start time” or “last seating time.” Such information may be prominently reflected in connection with the operating hours. User interface 701 of FIG. 7 shows an example of this. As shown, the “last seating” time may be shown in the bottom panel 720 of the calendar rather than operating hours. More specifically, during operating hours, the last seating time may be displayed. Outside of operating hours or for a date other than the present date, operating hours (or “tap to see hours”) may be displayed. It will be appreciated that diners, disappointed because they arrived at a restaurant during operating hours but after the last seating, is a significant problem that is not addressed by certain web resources.

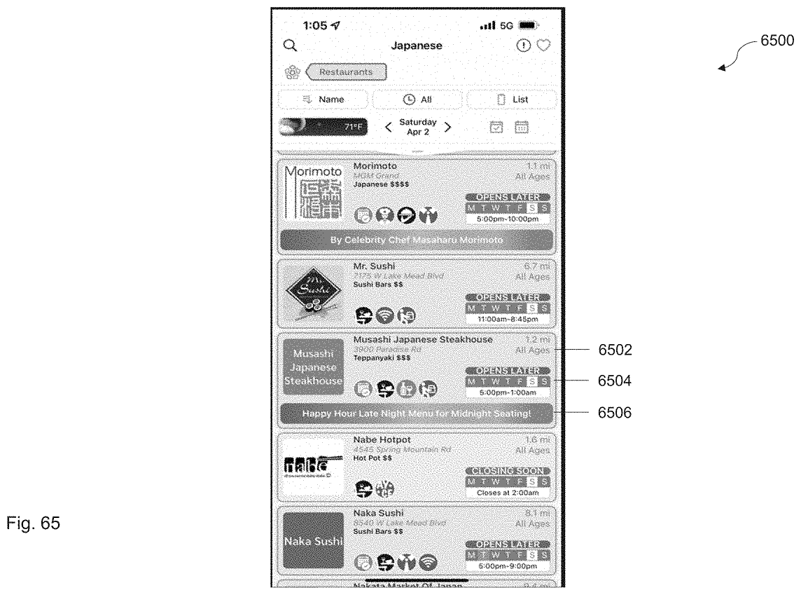

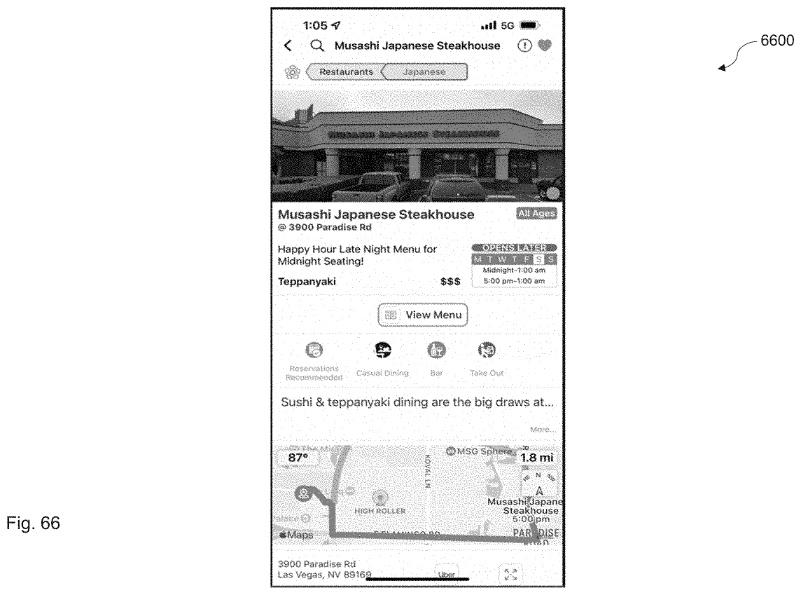

FIGS. 65-66 show another instantiation of the enhanced operating hours feature. Specifically, FIG. 65 shows a results page 6500 that may be presented upon selecting the category Restaurants and the sub-category Japanese. In this case, one of the search result items 6502 includes an interactive calendar 6504 and a service information banner 6506. As shown, the interactive calendar 6504 shows opening and closing times for the selected day. The banner 6506 includes further operating time information for the date selected in the interactive calendar 6504. Specifically, the banner 6506 shows that on the selected day (Saturday) that a happy hour late night menu is available for the midnight seating. That is, even though the restaurant is open until 1 am on that day, diners arriving after midnight may have a different menu or deals available. FIG. 66 shows a user interface screen 6600 that may be presented upon selecting the noted result item 6502 of FIG. 65. The screen 6600 includes similar information. Alternatively, the screen 6600 may include more detailed information about the happy hour late night menu (e.g., more detailed information) or a user interface element (e.g., an asterisk or information icon) may be provided in connection with the interactive calendar or banner of FIG. 65 or 66 to allow the user to access more detailed information about operating hours or associated products/services/deals.

The calendar 710 can provide operating hours information for multiple days, i.e., for one week in the illustrated example. As shown, the calendar 710 defaults to showing operating hours for the current day. In the illustrated example, the day is Thursday, and the calendar shows operating hours of 10:30 PM to 4:00 AM. However, the user can select any other day of the upcoming week and receive operating hours information for that day. System structure concerning such interactive elements will be described in more detail below.

The calendar 710 can indicate additional information. For example, the user may be able to immediately see that the club is closed on Monday and Wednesday night (e.g., because those dates are colored red) and that it is open early on Monday morning (e.g., because the top half of the Monday box is colored green). In this manner, the user can easily view operating hours information for an upcoming day, for example, if the user is planning future reservations or otherwise making future plans. Consider the case of a visitor to Las Vegas who may wish to plan his trip around a particular show. Thus, the visitor may wish to see a Cirque show such as “O.” However, “O” may be closed on Monday and Tuesday nights, indicated by red on the interactive calendar. Thus, the visitor can view the show in a list view and instantly see the schedule for the entire week. It is not necessary to navigate, for example, to the website for the show to obtain schedule information, thus simplifying planning and potentially avoiding mistakes.

The panel 712 may provide pertinent information about the source or promotional information. In this regard, the information in the panel 712 may be entered by a system administrator, for example, based on knowledge of the source or a review of promotional materials for the source, or may be provided by the source and updated on a periodic basis. For example, an official or employee of the source may log on to a source interface of the system to enter specials, promotions, or other current information of the source on a regular basis.

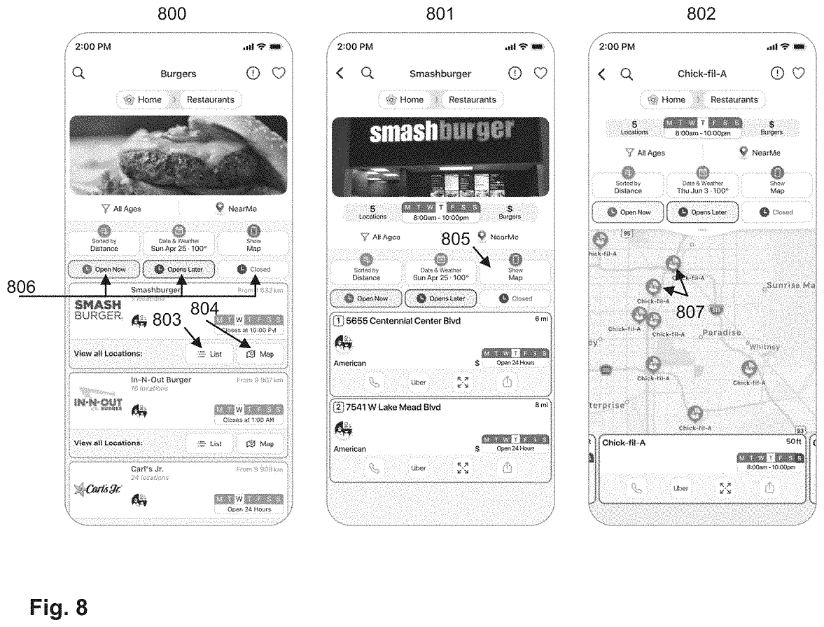

FIG. 8 illustrates a group and chain management function of the local information system. In some of the examples above, users search for sources of goods and services based on product or service categories, genres, or other attributes independent of any ownership or affiliation of the sources. However, in many cases, users may desire to filter search results based on some affiliation such as a group or chain. For example, a user may be interested in locating outlets of a favorite restaurant chain, identifying hotels or casinos that are part of a loyalty program that the user participates in, or other facilities where the user has an established line of credit or spending incentive. FIG. 8 shows a series of user interface screens 800-802 illustrating this functionality. Specifically, screen 800 shows a user interface that may be presented in response to entering the category of restaurants and the subcategory of burgers. In connection with search result items that are part of a chain, the user is presented with a button 803 to list the local outlets of that chain and a button 804 to provide a map of the local outlets of the chain. If the user selects the list button 803, a display such as screen 801 may be presented. For example, the user may receive a list of all the local Smashburger or Chick-fil-A outlets. If the user selects the map button 804 or the map button 805 on screen 801, the user will receive a map showing the locations of the local outlets (chick-fil-A in the illustrated example). In this manner, the user can readily identify preferred chains and affiliates in a list or map format.

FIG. 8 shows additional features of the local information system. Screen 800 shows status selection and mapping buttons 806. Using the status selection buttons, for example, the user can filter the results such as by using an “open now” filter, an “opens later” filter, and a “closed” filter. Thus, for example, if the user is immediately going to a burger restaurant, the user may choose to only display results for restaurants that are open now. Screen 802 shows icons identifying the locations of Chick-fil-A outlets on a map. These icons may convey a variety of information in addition to location. For example, the icons may be color-coded to identify status information such as open, closed, opens soon, closes soon, etc. In addition, the icons may include encoded information, or a user may roll over the icons to display additional information concerning services or features of the particular outlet, such as operating hours, curbside pickup available, dining room open, or other information.

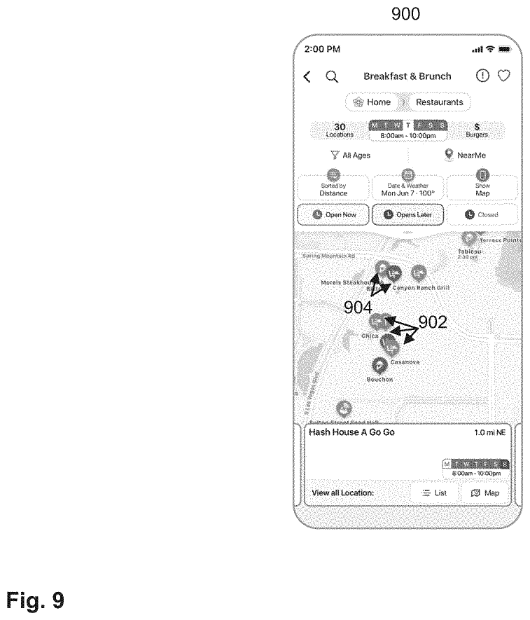

This is further illustrated in FIG. 9. In this case, a map 900 displays icons 902 showing the locations of various breakfast and brunch restaurants. As shown, the icons 902 may include graphical information 904 in connection with pins indicating, among other things, for restaurants, the style (i.e., fast food, casual dining, food trucks, fine dining, etc.) or other information. In addition, as discussed above, the icons may be color-coded or otherwise configured to identify restaurants are open, closed, opening soon, or closing soon.

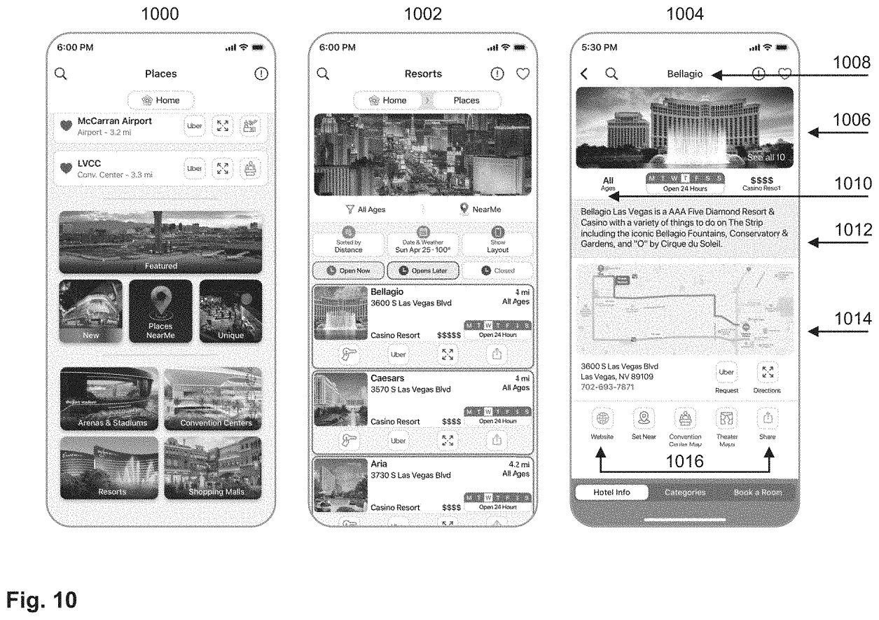

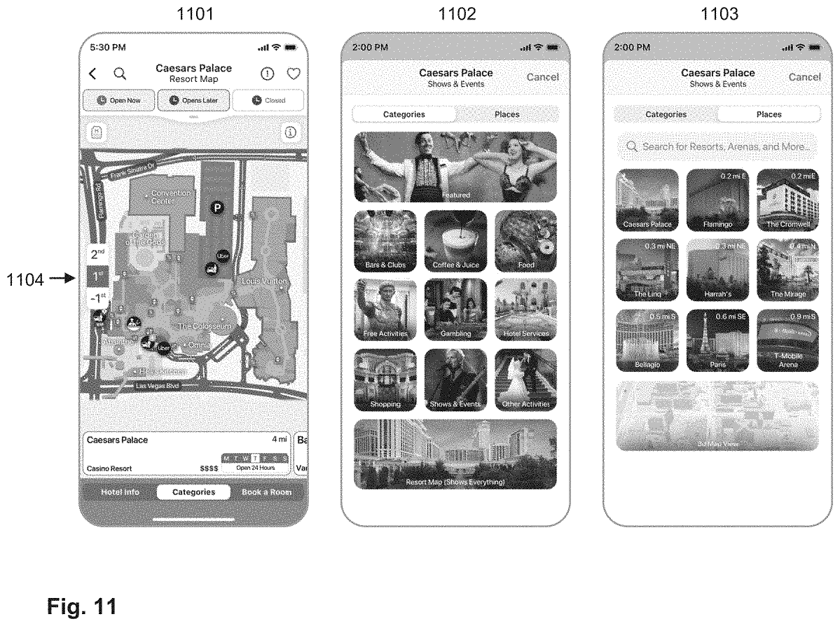

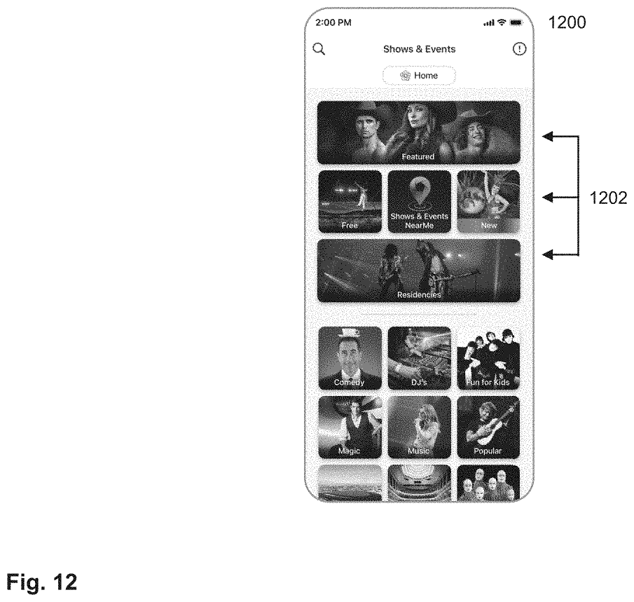

The places category of the local information system also includes novel features. FIG. 10 shows a screen 1000 that may be presented upon selection of the places category from the home screen. As shown, the screen 1000 includes graphical category selectors to select subcategories such as arenas and stadiums, convention centers, resorts, shopping malls, and others. Screen 1002 shows a user interface that may be presented upon selection of the resorts category. As shown, the screen 1002 includes search result items for resorts in the locality. If the user selects one of the resorts from the search results, a resorts page 1004 is displayed. The resorts page 1004 includes a variety of information about the selected resort. For example, page 1004 may include an image 1006 for the resort as well as the name 1008 of the resort and any restrictions 1010. The page 1004 also includes information describing the type of resort, an expense rating of the resort and an integrated, interactive weekly calendar. Panel 1012 provides a brief description of the resort. This description may be entered by a system administrator based on publicly available information or other information provided by the resort or may be entered by a representative of the resort.

The screen 1004 may also include a map 1014 showing the location of the resort and driving instructions including multiple route options and times. In addition, the screen 1004 provides contact information for the resort such as an address and phone number, and a button to arrange transportation. The illustrated screen 1004 also includes buttons 1016 to provide other functions related to the resort. For example, the buttons may include a resort map button, a theater button, a convention center button, a set near button, a website button and a share button. The convention center and theater buttons provide information regarding a convention center and one or more theaters included at the resort. The website button provides a link to a website for the resort. The share button allows user to share the resort information with other users. The set near button allows users to identify other sources of goods and services near the resort. Finally, the resort map button can be selected to provide a map of the resort that may include the locations of various amenities such as restaurants, health and fitness centers, convention center, casino, and the like.

FIG. 11 shows user interface screens 1101-1103 that may be presented in connection with the noted buttons 1016 of screen 1004. Screen 1101 shows a screen that may be presented upon selecting a resort map button. As shown, the screen 1101 includes a map of the resort showing various facilities including a convention center, parking, an Uber station, a valet station, and various other amenities. The buttons 1104 can be used to show maps of different floors of the resort. Screen 1102 includes visual category selectors for the resort. The available categories may vary depending on the resort. Screen 1103 shows nearby resorts that may be displayed by selecting the set near button. In connection with the resort map, walking directions to particular sources of goods and services within the resort may be provided. For example, the local information system may provide internal walking directions within the resort from the user's current location to a restaurant within the resort. In general, there are at least four ways that users can navigate to different resorts or places maps: 1) using the visual category system under the places category; 2) tapping the nearby places button on a displayed map to see a list of nearby other places maps to view; 3) from the nearby place screen, navigating from a 3D map to see any desired place in the system, and 4) selecting the magnifying glass icon and entering the name of the place of interest. The set near button changes the point from which the system determines distance calculations.

FIG. 12 shows a graphical user interface screen 1200 that may be displayed upon selecting the “Shows & Events” graphical user interface element from the home screen. As shown, the screen 1200 includes visual category selectors 1202 identifying show and event genres or other categories. For example, the illustrated selectors include free, new, comedy, fun for kids, music, and others.

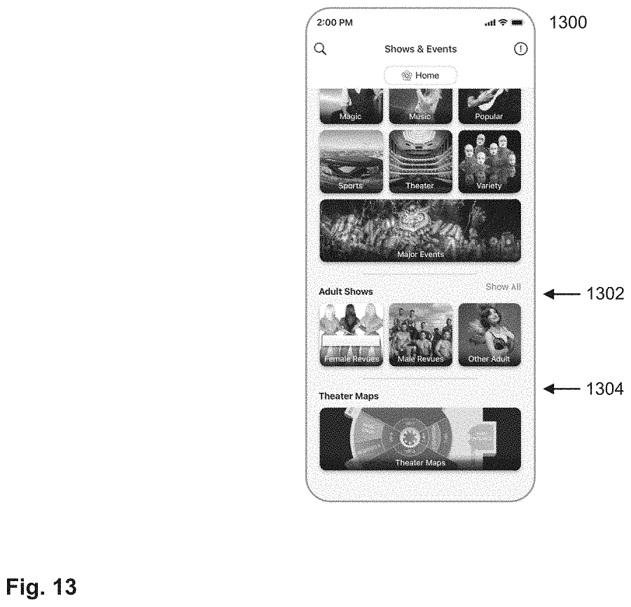

FIG. 13 shows a graphical user interface screen 1300 that may be accessed by scrolling down from the screen 1200 of FIG. 12. The shows and events landing screen may include additional visual category selectors organized, for example, in categories such as Adult Shows 1302 and Theater Maps 1304. The system may have content warning or identification labels for shows and events that may offend (or interest) certain users. Also, content may be hidden from view either 1) by using a content filter, or 2) by using an age filter.

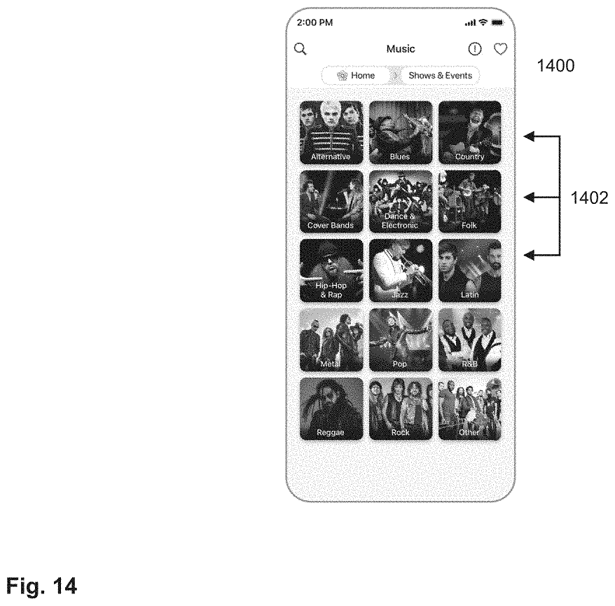

FIG. 14 shows a user interface screen 1400 that may be displayed upon selecting “Music” from the Shows & Events landing page. Again, visual category selectors 1402 are provided to enable selection of specific music genres or other categories. It will be appreciated that conventional websites for providing information about music shows or for purchasing tickets to such shows typically include a search icon, such as a magnifying glass, or pull-down textual filters for enabling users to find shows of interest. However, such search tools can be difficult to use, particularly for users who may not know what kind of show they are looking for or what category it falls into. The illustrated visual category selectors 1402 provided a more intuitive and faster way for users to identify shows of potential interest.

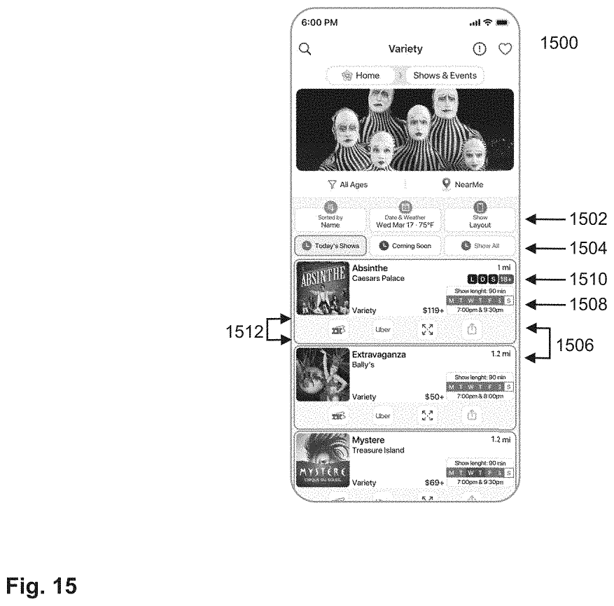

FIG. 15 shows a graphical user interface screen 1500 that is presented upon selecting one of the visual category selectors 1202 of FIGS. 12-13, in this case, the Variety selector. The illustrated screen 1500 includes information buttons 1502, date range selectors 1504, and search result items 1506. The information buttons 1502 provide date and weather information as well as providing sorting options and layout options for the search results. The date range selectors, in the illustrated example, allow the user to select today's shows, shows coming soon, or all shows. The search result items 1506 show the results in this subcategory sorted and laid out according to the selected options. As shown, the displayed items 1506 display shows that are responsive to the selected subcategory, a location and subcategory of the shows, pricing information, rating information 1510, and an integrated, interactive calendar 1508, among other things. As will be described in more detail below, the ratings information 1510 displays any ratings information related to the intended audience for the show.

The integrated, interactive calendar 1508 has been described above in other contexts. In this context, the calendar 1508 allows user to select any day of the week to get show time information for the relevant show. For example, the calendar 1508 may show, for a selected day of the week, show times and show length information. The interface 1500 also includes service buttons 1512 that, for example, provide links to purchase tickets, arrange transportation, expand the item, or forward the item to an intended recipient, for example, by text or email.

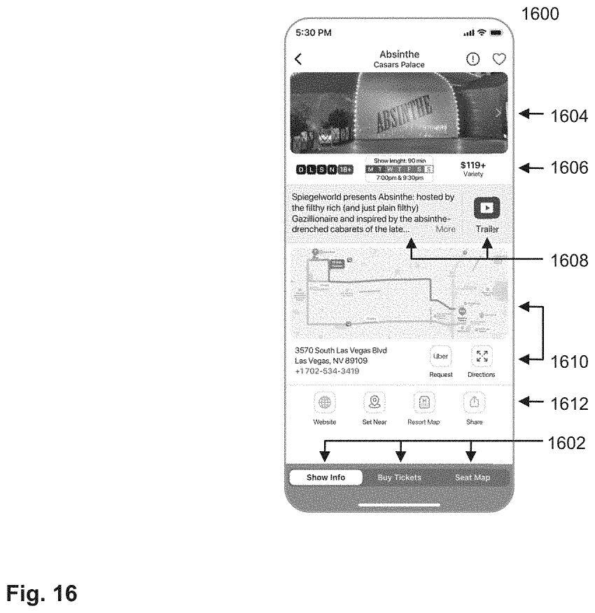

FIG. 16 shows a user interface screen 1600 that may be displayed when the user selects a search result item or expands a search result item. The interface 1600 includes buttons 1602 that allow the user to select show information, a show calendar, buy tickets, or a seat map for the selected show. In the illustrated example, the show information button has been selected. The screen 1600 further includes a selection of images 1604 related to the show that the user can browse through. In addition, the screen 1600 includes buttons 1606 that provide ratings information, an integrated, interactive calendar, and a link to purchase tickets. Screen section 1608 provides a description of the show and a link to any available trailer or other show information. Screen section 1610 provides a map with directions to the show theater from the user's current or selected location as well as address information, a phone number for the theater, and a link to arrange transportation. Finally, buttons 1612 provide links to a website of the theater, an option to set the theater location as a base location for identifying nearby services, a resort map to show the location of the theater within a resort, and a button to share the show information with an intended recipient.

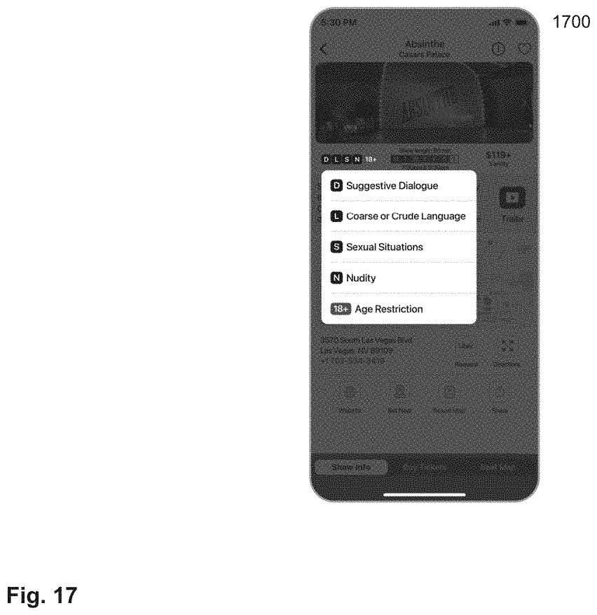

As noted above, in connection with search results for shows and events, various user interface screens may include ratings information. By clicking on the ratings information, the user can obtain information identifying intended audience ratings information associated with particular icons. FIG. 17 shows a drop-down menu 1700 including definitions for certain ratings information. In this case, the ratings icons include suggestive dialogue, coarse or crude language, sexual situations, nudity, and an adult age restriction.

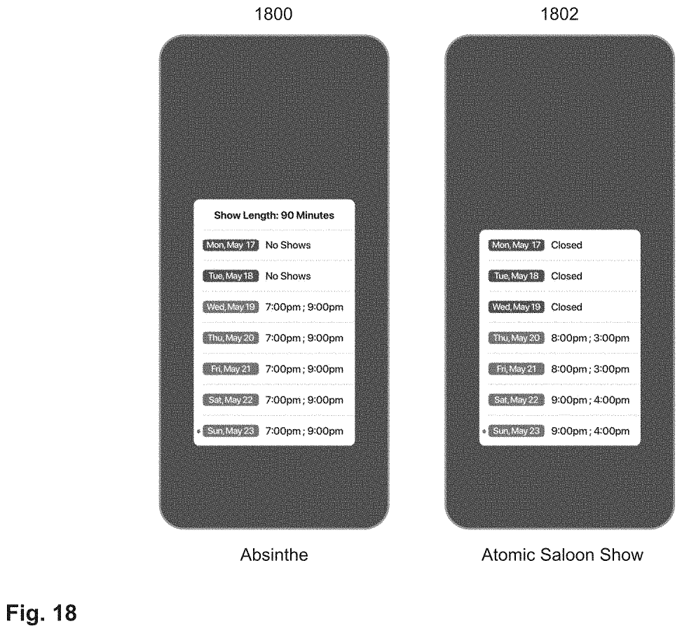

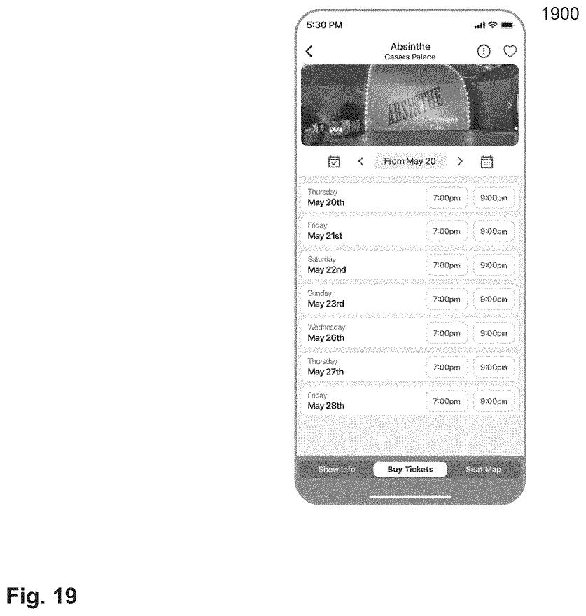

FIG. 18 shows two examples of user interface screens 1800 and 1802, for two different shows, that may be displayed upon selection of the calendar. As shown, the show calendar may indicate dates on which the theater is closed, dates where there are no shows, showtimes, and other information.

FIG. 19 shows a user interface screen 1900 that may be displayed upon selection of the show calendar button. The user can select date ranges to see corresponding show information. In the illustrated example, dates within the range are displayed as search result items with date and show time information.

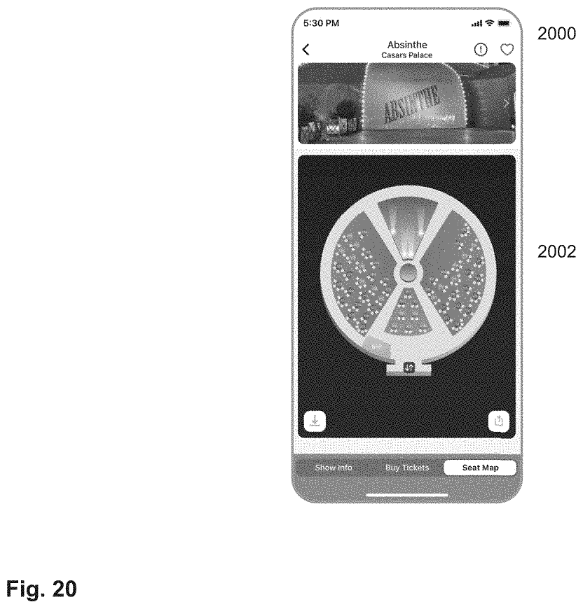

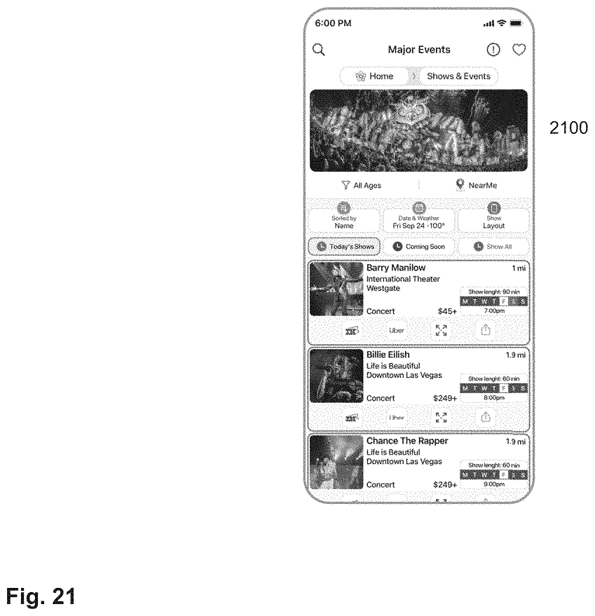

FIG. 20 user interface screen 2000 that may be displayed upon selection of the seat map button. In this case, a seat map 2002 is displayed for the Absinthe Theater at Caesar's Palace. The map 2002 may identify seating sections together with information concerning available seats in the sections for a selected date or pricing information. For example, such information may be provided by color coding or by hovering over or selecting the relevant section.

FIG. 21 shows a user interface screen 2100 that may be displayed upon selection of the subcategory of Major Events within the category of Shows & Events. The screen 2100 includes sections and buttons similar to those described above. These include a variety of options for sorting the results, laying out the results. The screen 2100 also shows search result items with relevant show information.

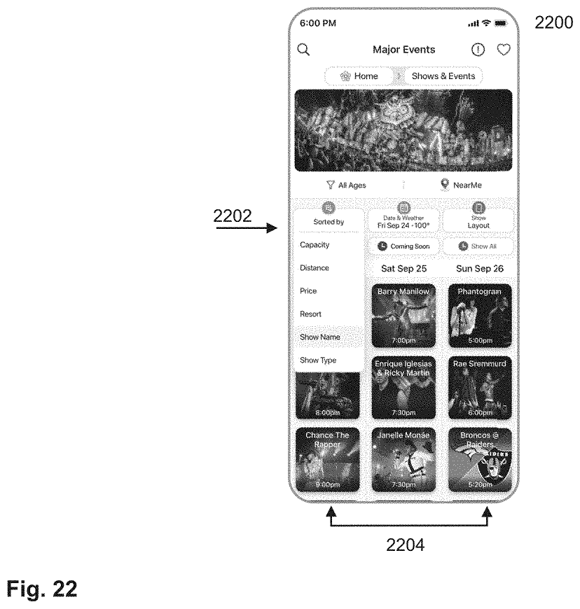

FIG. 22 illustrates options for sorting the results. As shown, the user interface screen 2200 includes a button 2202 for selecting how the search results are sorted. When the button 2202 is selected, a drop-down menu provides sorting options. In this case, sorting options include sorting by the capacity of the theater, sorting by distance from the user's current location or a selected location, sorting by price, sorting by resort, sorting by show name (e.g., alphabetically), and sorting by show type. The screen 2200 also includes search results organized in a grid 2204 as will be described in more detail below.

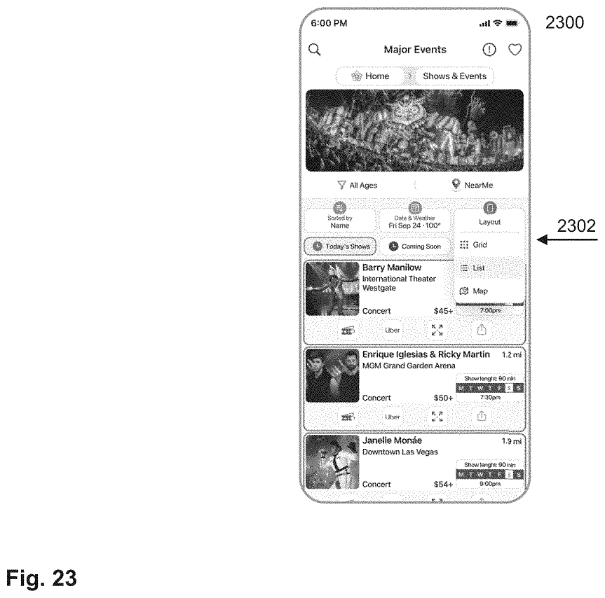

FIG. 23 illustrates options for how the search results are laid out. As shown, the user interface screen 2300 includes a button 2302 to select layout options. In the illustrated example, the layout options include laying out the results in a grid, laying out the results in a list, or displaying the results on a map.

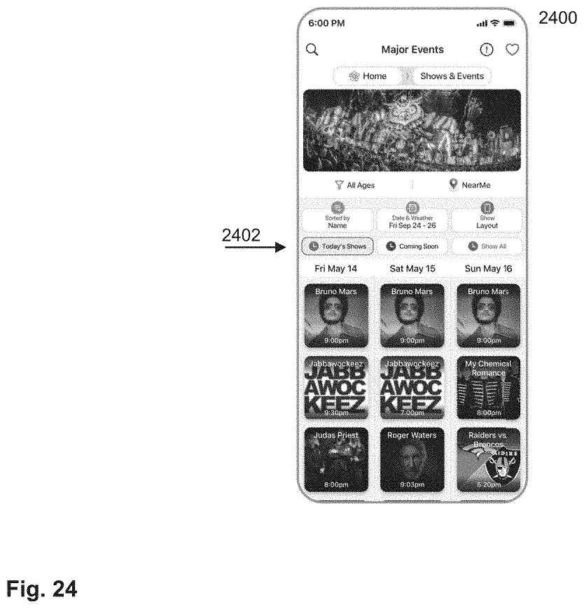

FIG. 24 illustrates different options for the time frame of the displayed results. The illustrated user interface screen 2400 allows user to select results for today's shows, shows coming soon, or all results. In this case, the Today's Shows button 2402 has been selected. Consequently, in the case of a grid layout, today's shows will be shown in the first column of the grid, with subsequent days in successive columns.

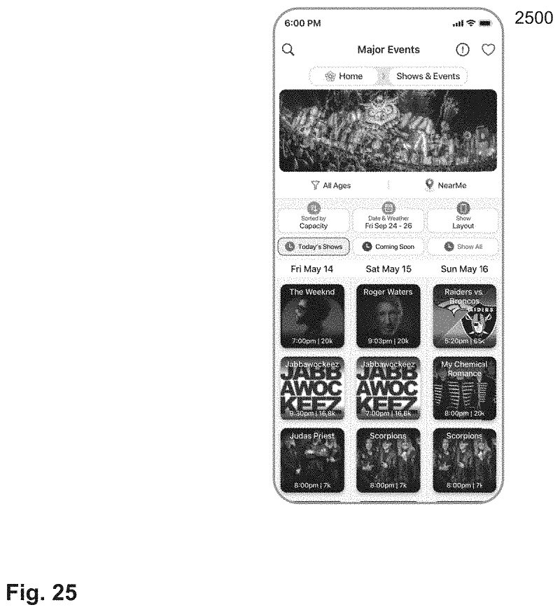

FIG. 25 shows a user interface screen 2500 that illustrates the results of one combination of a selected sort filter and layout arrangement. In this case, results are sorted by theater capacity and the results are arranged in a grid layout. Moreover, a current date range is selected that includes shows for the current day as well as tomorrow's shows and the day after's shows in successive columns. Thus, today's shows are shown in the leftmost column, tomorrow's shows are shown in the center column, and the day after's shows are shown in the far-right column. Within the columns, the shows are arranged by theater capacity with the largest theaters shown at the top of the column. Each of the results is identified by a visual selector associated with the corresponding show. Thus, a user can select any of the selectors to get more detailed information about the show as well as links to purchase tickets and arrange transportation. It will thus be appreciated that the interface screen 2500 provides a great amount of information in a form that is easy to understand and use.

FIGS. 26-27 illustrate the functionality of the Date & Weather button. Specifically, FIG. 27 shows two user interface screens 2700 and 2702. As shown, user interface screen 2700 includes a Date & Weather button 2704. Screen 2702 shows expansion of the Date & Weather display 2706 upon selection of the button 2704. As shown, the expanded display 2706 includes additional environment information such as the expected high and low temperature, expected winds, time of sunrise and sunset, and the like. It will be appreciated that such details may be important in connection with making arrangements for certain activities such as determining a tee time for golf, making arrangements for outdoor dining, and various other activities. As shown, the temperature displayed on the button 2704 may be a current temperature rather than an expected high or low temperature.

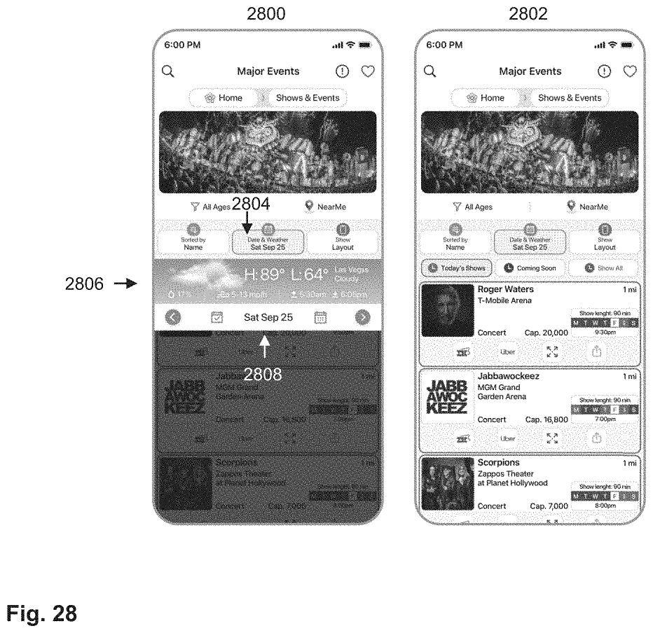

In some cases, for example, in connection with making arrangements for a future date, it may be desirable to display environmental information associated with the future date. FIG. 28 shows an example of this. Specifically, FIG. 28 shows two user interface screens 2800 and 2802. The Date & Weather button 2804 includes a calendar button 2808 that can be used to select a date other than the current date for display. In this case, the user has selected tomorrow's date for the display. Accordingly, no current temperature is shown on the button 2804. When the button 2804 is selected, predicted or expected conditions for the selected date are shown. In this case, the predicted high and low temperature, wind speeds, sunrise and sunset for the selected date are populated in the display 2806. If a date significantly in the future is selected, average weather information as well as expected sunrise and sunset for that date may be displayed.

The environmental conditions display may vary between a daytime display and a nighttime display. For example, the default display may be the nighttime display between sunset and sunrise and may be the daytime display between sunrise and sunset. Additionally, or alternatively, the user may select either the daytime display or the nighttime display. FIG. 26 shows examples of a nighttime display including a Fahrenheit display 2600 and a Celsius display 2602. The user may select Fahrenheit or Celsius in a settings utility of the application or the user device. Similarly, such settings may allow the user to select to display distances in miles or kilometers. Such settings may be inferred from a home location, IP address, or language of the user. The nighttime display may include information similar to the daytime display as described above, but with different graphics. Thus, the daytime display may include graphics of the sun, clouds, and precipitation icons to convey weather information such as sunny, partly cloudy, cloudy, rain, or snow. In the case of the nighttime display, similar graphics may be presented but with an image of the moon. Moreover, the phase of the moon may be shown such as full moon, half moon, crescent moon, and the specific phase of the moon such as various waxing or waning states may be indicated by the moon graphical element. Clouds and precipitation may also be indicated. It will be appreciated that some users may be interested in the phase of the moon, for example, out of general interest or because certain activities, such as nighttime hikes, may be affected by the phase of the moon.

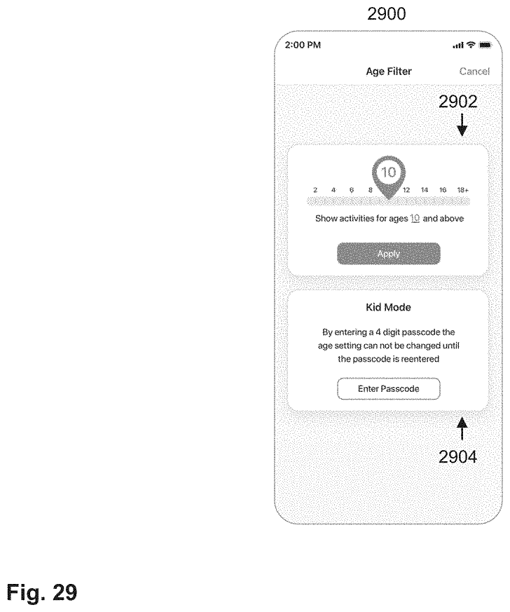

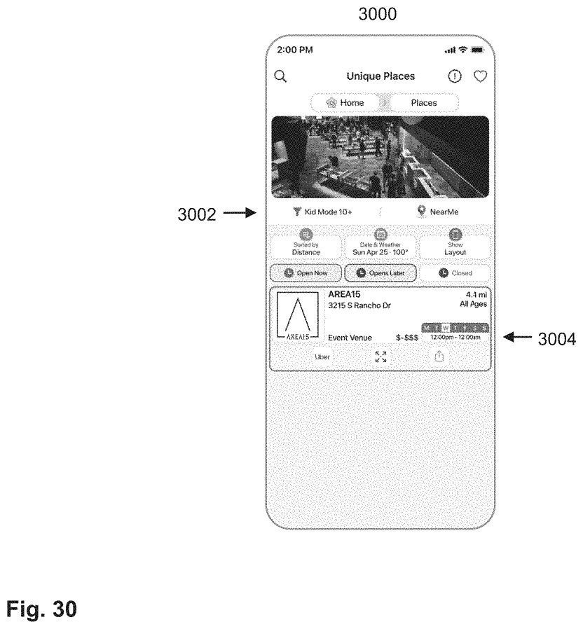

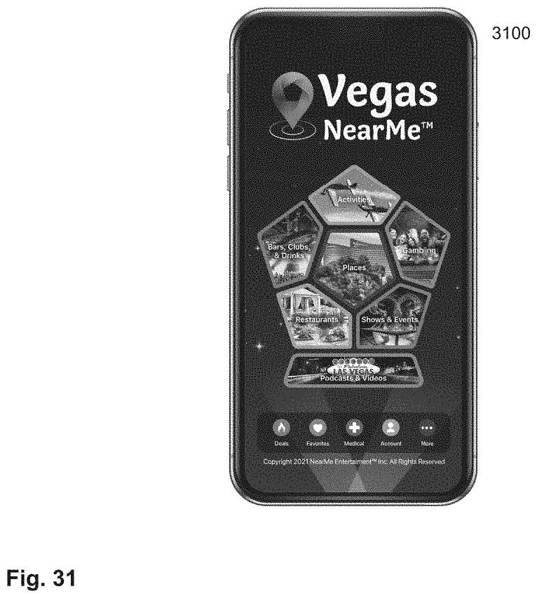

FIG. 29 shows a user interface screen 2900 that may be used to set and apply an age filter. For example, an age filter may be used to operate in a kid safe mode or to specifically identify adult themed activities. Thus, the filter may operate to include all age-appropriate activities or to exclude age-inappropriate activities. The illustrated screen 2900 includes a section 2902 for setting an age parameter and applying the age parameter. Conveniently, the age limit may be set by dragging and dropping an icon. Section 2904 can be used to enter a passcode to operate in kid safe mode. This prevents disabling of the kid mode without entering a passcode.

FIG. 30 shows a user interface screen 3000 that may be displayed when an age filter 3002 has been applied. The age filter affects the results 3004 that are displayed on the screen 3000. As noted above, the age filter may operate to include all results 3004 that are included within the age range. Thus, in this case, with a filter of 10+, the results 3004 include one result appropriate for all ages and another result appropriate for ages over 21. Alternatively, in a kid safe mode, certain age ranges may be excluded. Thus, for example, if a kid safe mode was selected, the second illustrated result 3004 intended for audiences over 21 could be excluded.

FIGS. 31-44 show further examples of user interface screens of a local information system in accordance with the present invention. In some cases, these are updates or alternatives to some of the screens described above.

FIG. 31 a home user interface screen 3100 for the local information system. The screen is similar to that shown in FIG. 4. This element can be selected to access information about online content about the locality (in this case, Las Vegas, Nev.) such as podcasts and vlogs. In particular, this category will provide information about online content of interest to those seeking information about goods and services available in the locality. For example, this would include online content of interest to people from other places planning trips to the locality.

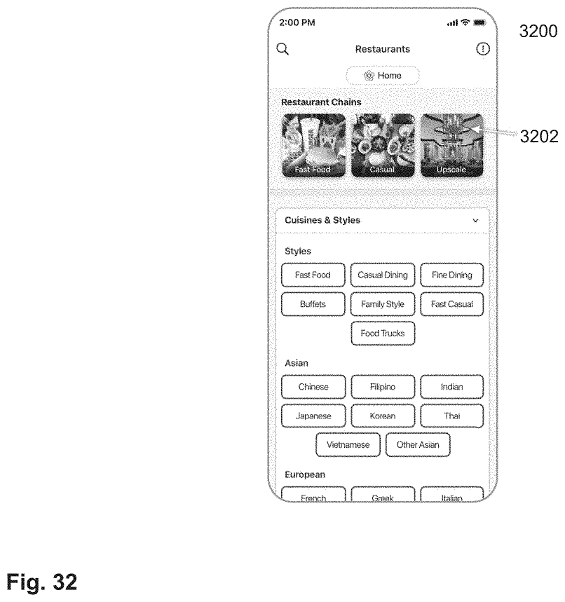

FIG. 32 shows a user interface screen 3200 that may be included in the “restaurants” category. As shown, the screen 3200 includes a row 3202 for restaurant chains. A user can select interface elements “fast food,” “casual,” or “upscale” to access information about corresponding chains. As discussed above, such information can be presented in list and/or map form. In this manner, users can easily access information regarding favorite chains organized by chain for improved convenience. The interface also organizes information by cuisines and styles for those who are not focused on particular chains.

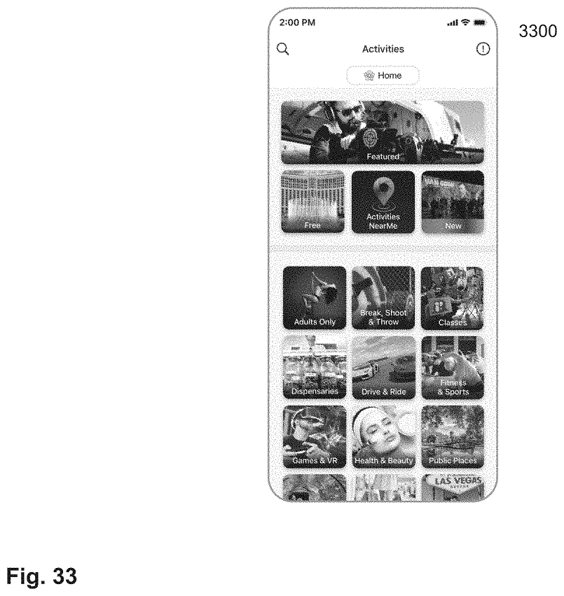

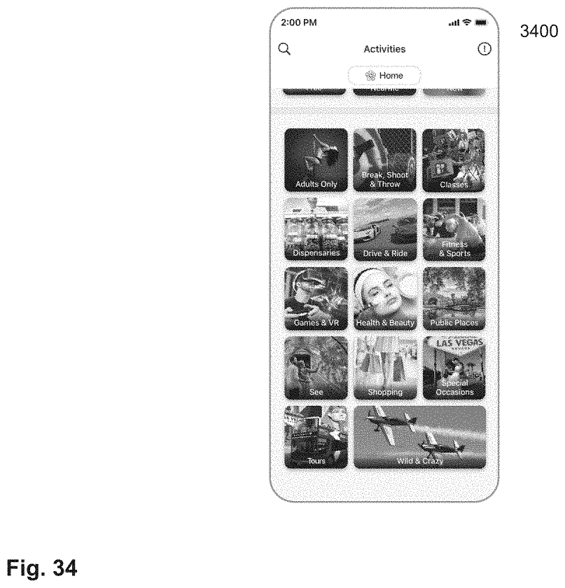

FIGS. 33-34 show an alternative arrangement of interface elements for the “activities” category. In particular, FIG. 33 shows the top portion of the landing screen 3300 for the category and FIG. 34 shows the bottom portion of the screen 3300 (e.g., accessed by scrolling). This screen is reorganized and includes different subcategories in relation to the activities screen shown in FIG. 5.

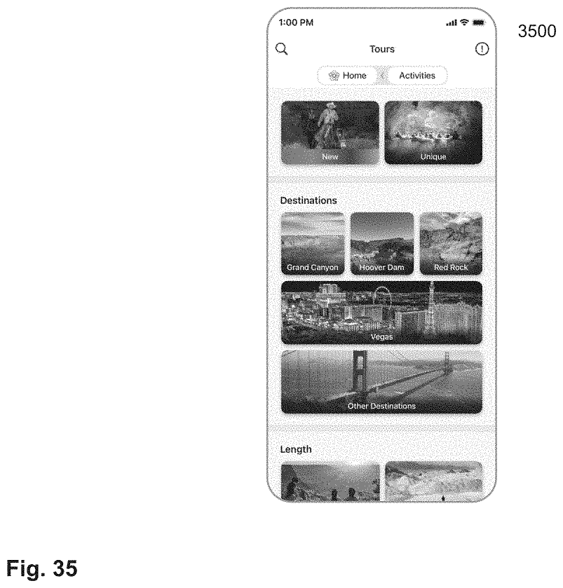

FIG. 35 shows a user interface screen 3500 that may be presented upon selecting the category “tours.” The user can peruse available tours based on various criteria such as the tour destination, the length of the tour (e.g., in days), or other criteria.

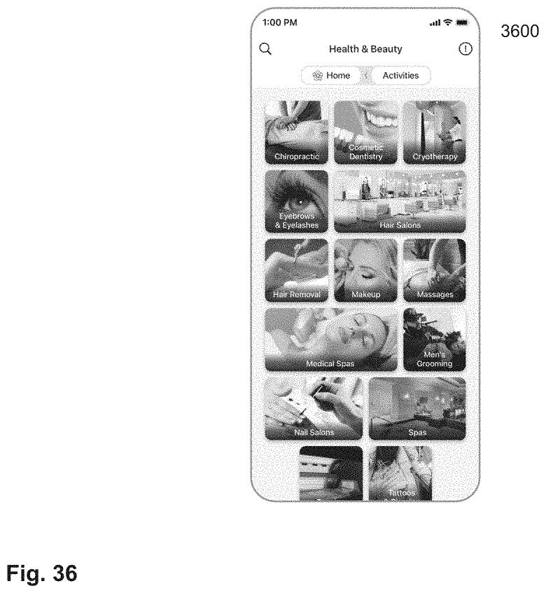

FIG. 36 shows a screen 3600 that may be presented upon selecting the “health and beauty” category under activities. This category may include a variety of subcategories related to health and beauty such as chiropractic, hair salons, medical spas, etc.

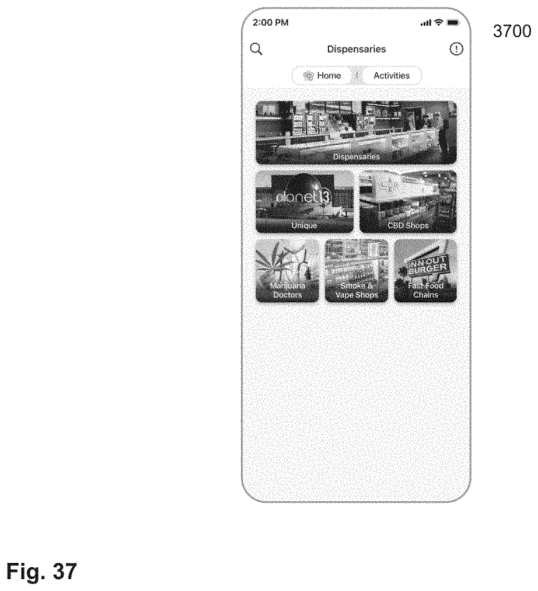

In some localities, dispensaries may be available. FIG. 37 shows a screen 3700 that presents information regarding dispensaries and other subcategories of potential interest such as fast-food chains.

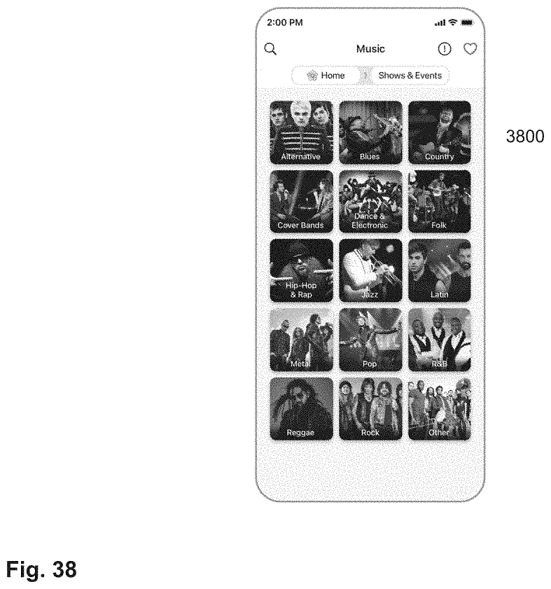

FIG. 38 shows a screen 3800 that presents information about local music. In this case, a user can obtain information about shows and events for various music genres.

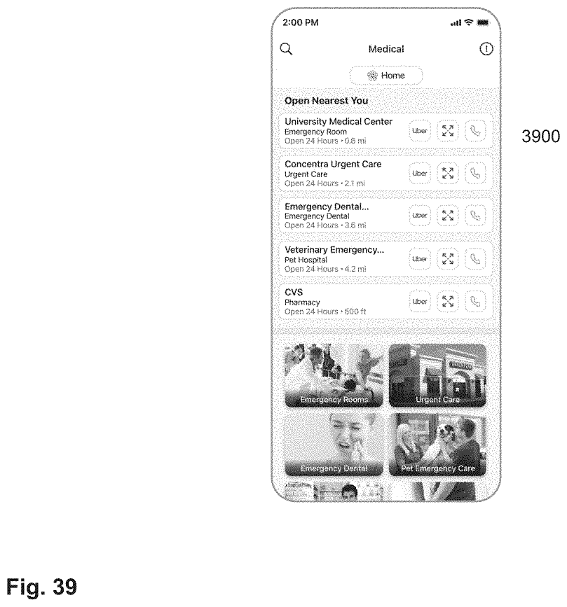

One type of service of particular importance is medical information, particularly in an urgent or emergency context. In such cases, it may be of great value to be able to quickly identify an appropriate facility for the needed services as well as to identify facilities that are available and include any critical capabilities, e.g., an emergency room. FIG. 39 shows a screen 3900 that may be presented upon selecting the medical category. As shown, the screen includes interface elements for subcategories such as “emergency rooms” and “urgent care.” The results may be filtered to prioritize, for example, emergency services, nearby facilities and/or facilities that are currently open.

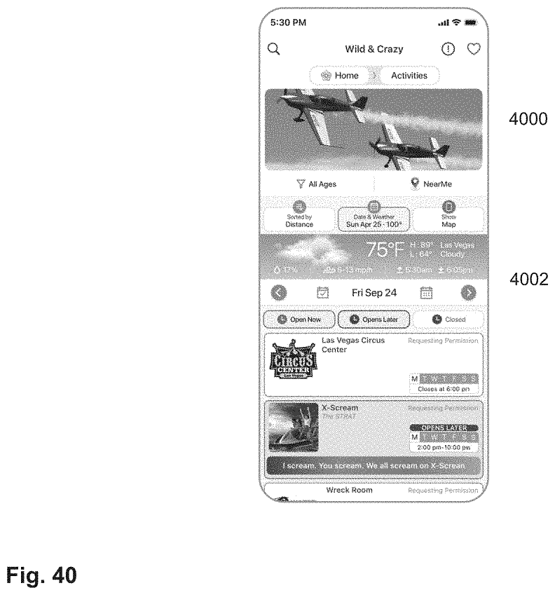

FIG. 40 shows a screen 4000 that may be presented upon selecting the activities category and wild and crazy subcategory. The screen 4000 shows results, for example, organized based on filter settings relating to opening time. The screen 4000 also shows an updated or modified presentation of date and weather information in panel 4002. The panel 4002 provides image and text-based information concerning, for example, current temperature, expected high and low temperature, wind, sunrise and sunset, and other weather conditions. Such conditions can be presented for the current day or for a selected date.

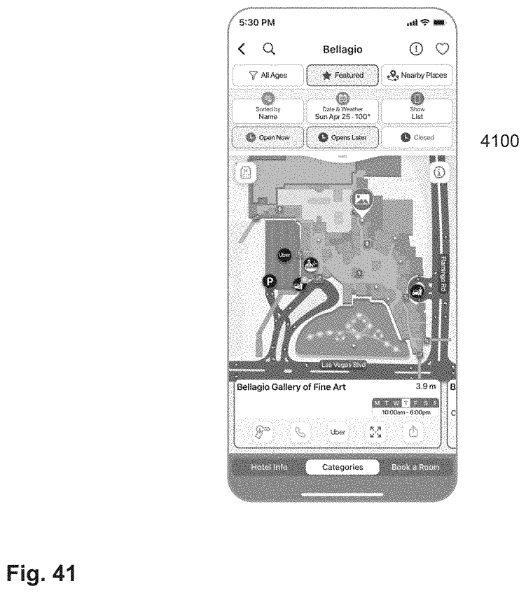

FIG. 41 shows a screen 4100 that may be presented upon selecting resorts and then selecting a specific resort (in this case, Bellagio) and the category “featured.” The results include a map of the resort including icons showing various services available such as Uber rides, valet parking, dining, etc.

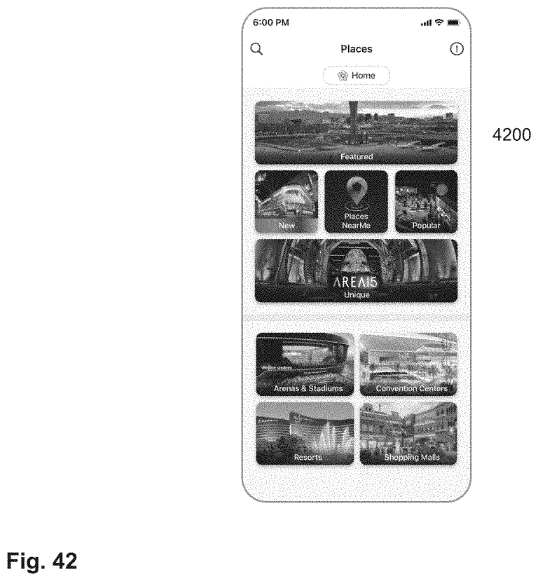

FIG. 42 shows an updated or alternative screen 4200 that may be presented upon selecting the category “places.” As shown, the user can select from various subcategories such as “new,” “near me,” “popular,” “resorts,” “shopping malls” etc.

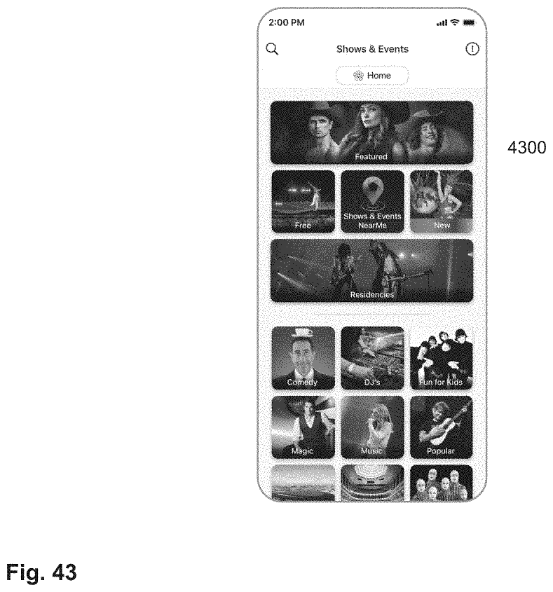

FIG. 43 shows a screen 4300 that may be presented upon selecting the category “Shows and Events.” A user can select subcategories including “featured,” “free,” “new,” “unique,” “residencies,” “comedy,” “fun for kids” etc. Specific items may be categorized under such headings by a subject matter expert, by predefined criteria, by reference to published or private information sources, or other criteria. For example, particular service outlets may pay a premium to be listed in the “featured” category if desired.

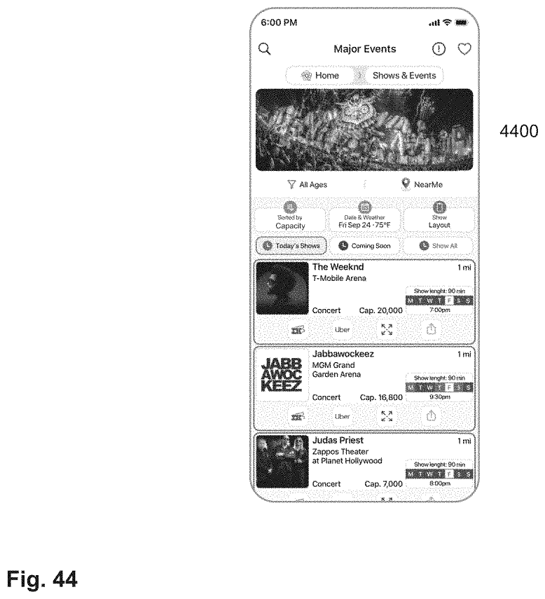

FIG. 44 shows a screen 4400 that may be presented to provide information about major events in the locality. Such events may be selected based on popularity, venue, social media trends, or other criteria for identifying significant events.

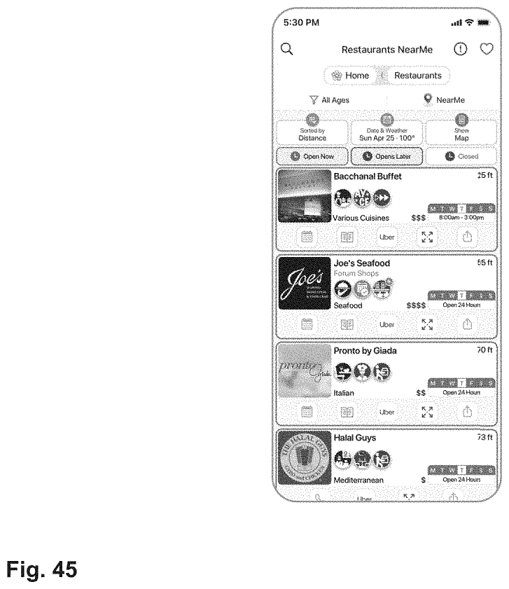

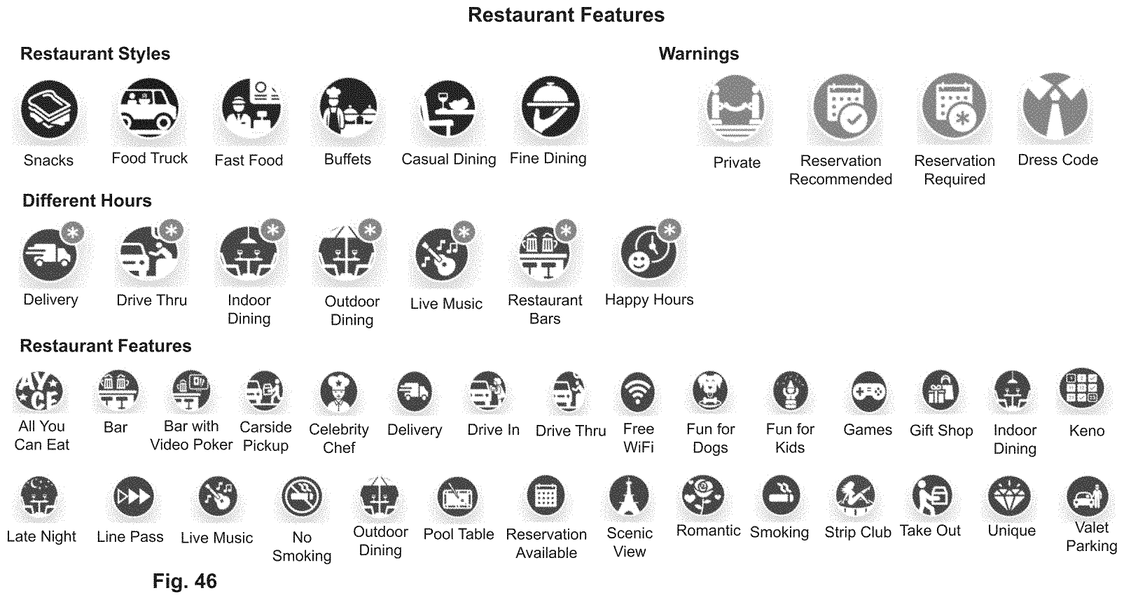

FIG. 45 shows a screen that may be presented when the user selects the “Restaurants NearMe” category while in a resort, in this case, Caesar's Palace. In this case, distances may be shown in feet (or meters). FIG. 45 also shows feature icons that may be presented for various restaurants. FIG. 46 shows a list of exemplary type, warning, and feature icons that may be provided for restaurants. Of course, different icons will be provided for other categories. For example, a hiking trail may have an icon to indicate “easy,” “moderate,” or “advanced,” or a warning icon such as “scrambling,” “steep drop-offs,” or “no dogs allowed,” or a feature icon such as “view of the city” or “waterfall.” Such features and warnings may also be used in relation to dynamic filtering as described above. For example, blackjack tables might be sorted by “minimum bet size” or gentlemen's clubs may be sorted by “beer prices.” When users do such a custom sort, the features that the users are interested in may be shown in the search result boxes in place of what would otherwise be shown by default.

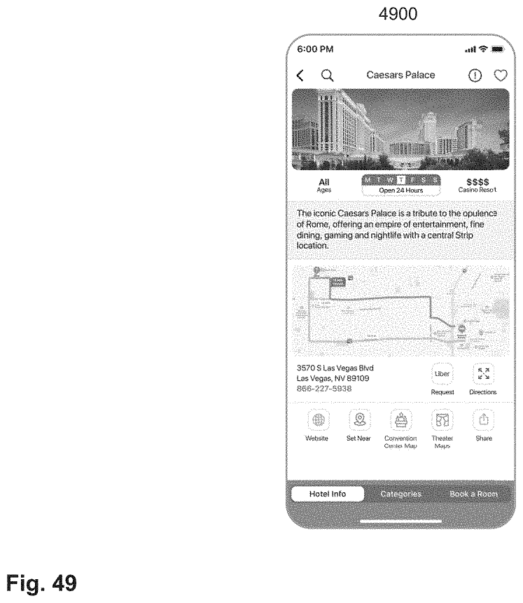

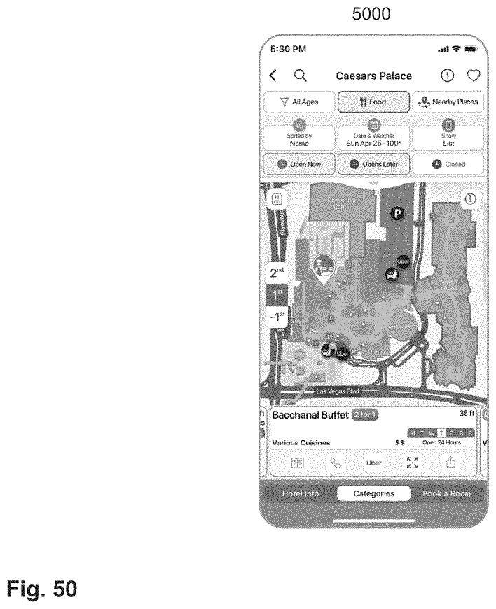

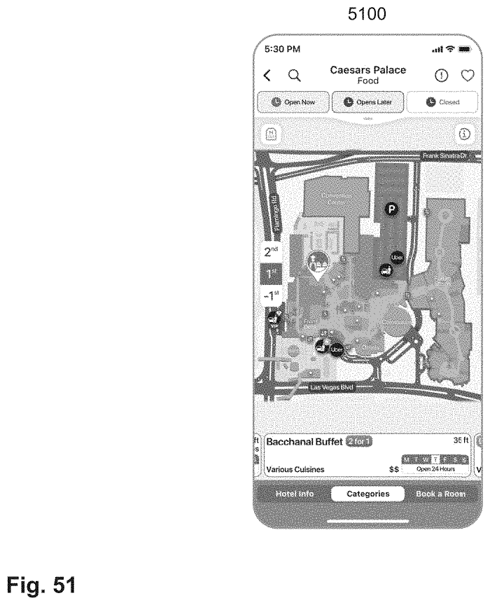

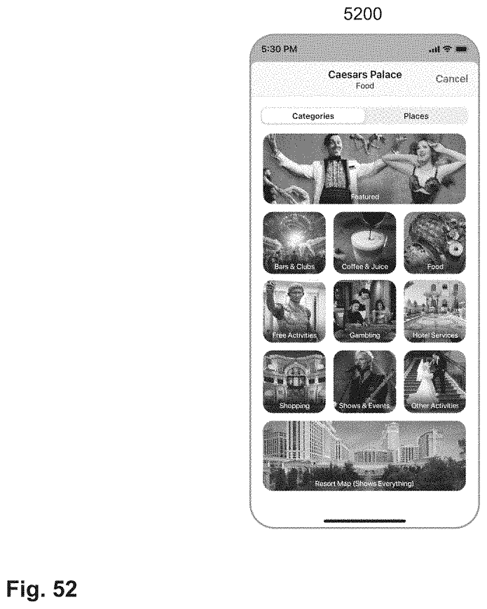

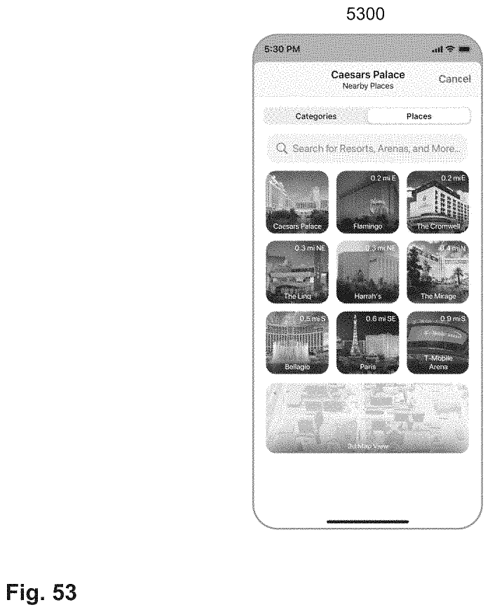

FIGS. 49-52 show additional user interface screens associated with the “places” category. Specifically, FIG. 49 shows an initial screen that may be displayed upon navigating to “Caesars Palace” within the “places” category. In particular, the illustrated screen provides hotel information for Caesars Palace. Screen 50 shows a map of Caesars Palace with the categories tab selected and the food filter applied. Results may be displayed beneath the map. FIG. 51 shows a screen with the categories tab and food category selected. It will be appreciated that results are only displayed for food within Caesars Palace. In both FIGS. 50 and 51, the “open now” and “opens later” filters are also applied. FIG. 52 shows subcategories that are available for selecting within the Caesars Palace category. Finally, FIG. 53 show a user interface screen that may be displayed when “nearby places” is selected within the Caesars Palace category.

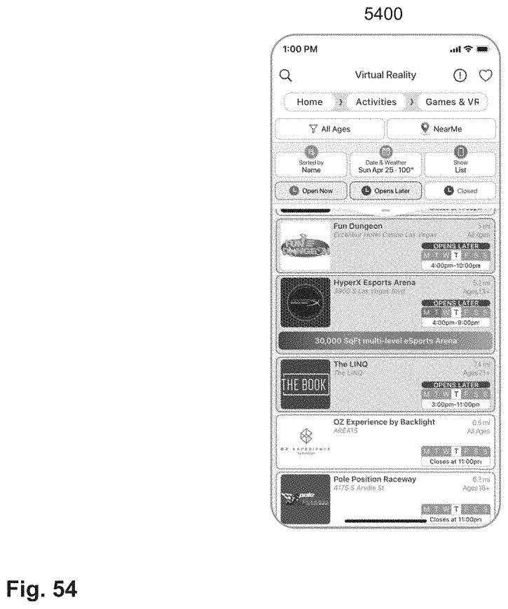

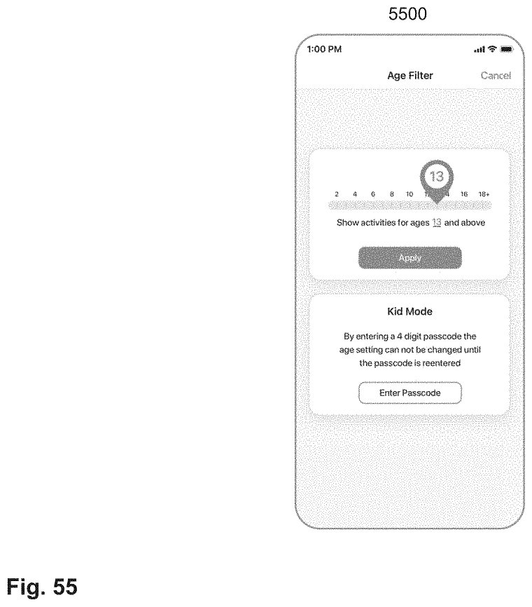

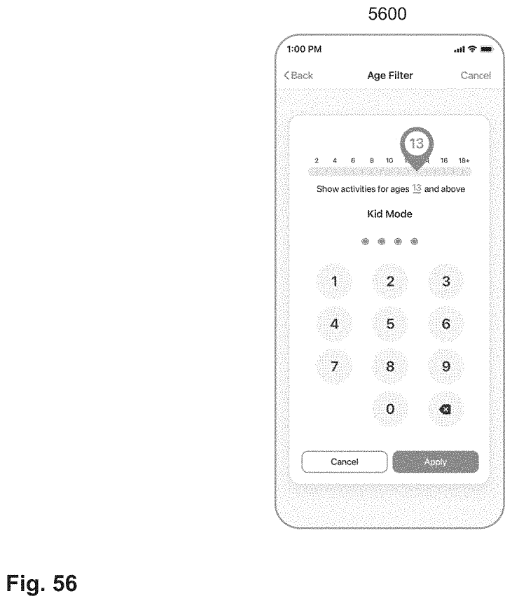

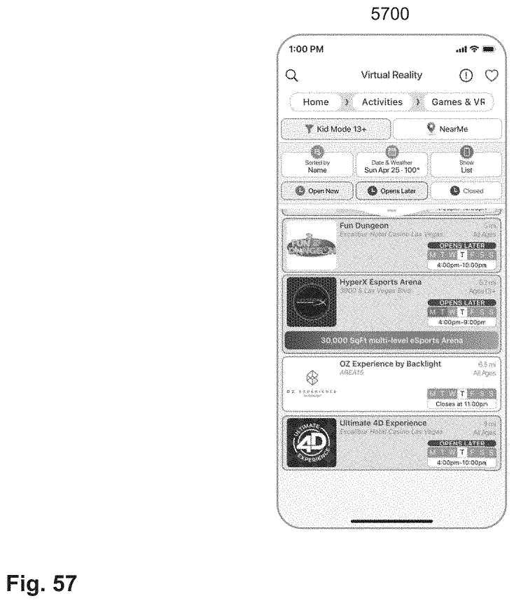

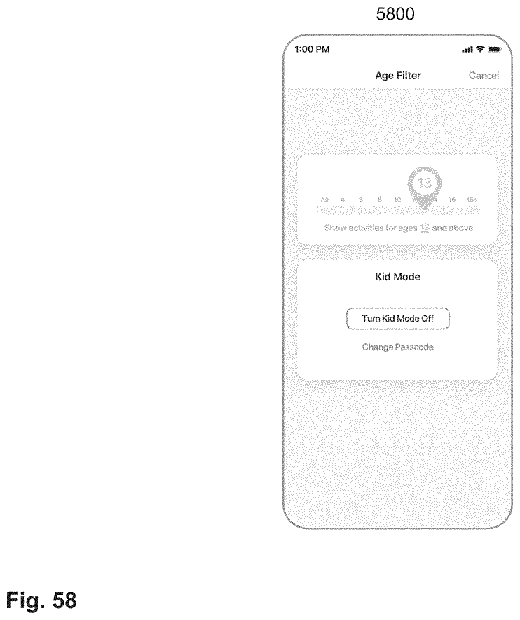

FIGS. 54-58 illustrate the kids filter feature. In particular, FIG. 54 shows a search results page that a kid might navigate to, in this case, a “virtual reality” page under the category “games and VR.” The illustrated results are not filtered by age or stated differently, show results for all ages. FIG. 55 shows an age filter page. On this page, the user can move an icon or cursor to select an age to use for the filter. In this case, the age 13 is selected meaning that activities will be shown rated for ages 13 and above. FIG. 56 shows how the age filter is set. As shown, a passcode can be entered and the “apply” button can be selected to set the filter. The passcode would also be required to change or cancel the filter. FIG. 57 shows a results page like FIG. 54 but with the new age filter applied. In this case, the age filter box now reads “Kid Mode 13+,” and the results are filtered accordingly. FIG. 58 shows a screen that can be used to turn the kids filter off.

Additional items of information may be provided in various user interface screens, for example, in the rectangular boxes shown in the list view and at the bottom of the map views. For example, just below the name of the business and location and to the right of the logo in search result pages, some of the more important feature icons and warnings may be shown. Depending on the screen size of the user device, 3 or 4 of the most important icons may be shown in these boxes, and the icons that are relevant for the specific business will be shown on each detail page. The more important feature icons and warnings may be selected based on the nature of the category, e.g., different icons may be selected for “hikes” than for “shows.” Below this and on the bottom left-hand side of the box, just to the right of the logo, the business type or sorting selections may be shown. Finally, to the right of this and just to the left of the visual week calendar, icons may be provided to show the relative cost of the activity, e.g., $, $$, $$$, and $$$$. The user's desired sort criteria may be shown, if it's not already shown, on screens throughout the local information system. For example, in the case of restaurants, this may be shown where the cuisine type is shown.

The user interface screens described above are examples that illustrate various functionality of the invention. It will be appreciated that these screens are not intended to be an exhaustive listing of the screens that would be provided in the local information system. Moreover, different categories, subcategories, and arrangements may be used for systems covering different localities depending, for example, on the specific goods and services available in that locality. However, to provide some appreciation of the hierarchy of categories and subcategories that may be provided in a particular example system, as well as the arrangement thereof, the following listing is provided for a system for Las Vegas, Nev. While this is a more comprehensive listing, it is still not exhaustive and is expected to evolve over time.

VegasNearMe Categories & Subcategories:

| 1. | Activities | |
|---|---|---|
| | a. | Featured |
| | b. | Free |
| | c. | Activities NearMe |
| | d. | New |
| | e. | Adults Only |

| | |
|---|---|
| i. | All Gentlemen's Club |
| ii. | Nude Clubs |
| iii. | Topless Clubs |
| iv. | Male Strip Clubs |
| v. | Coed Strip Clubs |

| | |
|---|---|
| f. | Other Adults Only |

| | |
|---|---|
| i. | Adult Museums |
| ii. | Adult Shopping |
| iii. | Brothels |
| iv. | Classes & Games |
| v. | Social Clubs |

| | |
|---|---|
| g. | Break, Shoot & Throw |

| | |
|---|---|
| i. | Break & Throw |

| | |
|---|---|
| (1) | Axe Throwing |
| (2) | Rage Rooms |

| | |
|---|---|
| ii. | Guns |

| | |
|---|---|
| (1) | Indoor Ranges |
| (2) | Outdoor Ranges |
| (3) | Machine Guns |
| (4) | Trap & Skeet |
| (5) | Shooting Sports |
| (6) | Unique Shooting |

| | |
|---|---|
| iii. | Other shooting |

| | |
|---|---|
| (1) | Bows & Arrows |
| (2) | Laser Tag |
| (3) | Paintball |

| | |
|---|---|
| h. | Classes |

| | |
|---|---|
| i. | Acting |

| | |
|---|---|
| (1) | Improv |
| (2) | Television/Screen |
| (3) | Theater |
| (4) | Other Acting |

| | |
|---|---|
| ii. | Adults Only |

| | |
|---|---|
| (1) | Pole Dancing |
| (2) | Other Adults Only |

| | |
|---|---|
| iii. | Arts & Crafts |

| | |
|---|---|
| (1) | Drinks & Crafts |
| (2) | Painting |
| (3) | Pottery |
| (4) | Sewing/Quilting |
| (5) | Other Arts & Crafts |

| | |
|---|---|
| iv. | Cooking |

| | |
|---|---|
| (1) | Vegan & Vegetarian |
| (2) | Other Cooking |

| | |
|---|---|
| v. | Dancing |

| | |
|---|---|
| (1) | Ballroom |
| (2) | Hip-Hop |
| (3) | Modern |
| (4) | Salsa |
| (5) | Other Dancing |

| | |
|---|---|
| vi. | Driving |

| | |
|---|---|
| (1) | Drivers Ed |
| (2) | Other Driving |

| | |
|---|---|
| vii. | Fitness |

| | |
|---|---|
| (1) | Aerial |
| (2) | Barre |
| (3) | Boot Camp |
| (4) | Climbing |
| (5) | Cross Fit |
| (6) | Cycling |
| (7) | Kettle Bell |
| (8) | Pilates |
| (9) | Weight Loss |
| (10) | Yoga |
| (11) | Other Fitness |

| | |
|---|---|
| viii. | Flying |

| | |
|---|---|
| (1) | Airplanes |
| (2) | Helicopters |
| (3) | Other Flying |

| | |
|---|---|
| ix. | Gambling |

| | |
|---|---|
| (1) | Blackjack |
| (2) | Craps |
| (3) | Dealers |
| (4) | Poker |
| (5) | Other Gambling |

| | |
|---|---|
| x. | Health & Beauty |
| xi. | Languages |

| | |
|---|---|
| (1) | English |
| (2) | Other |

| | |
|---|---|
| xii. | Music |

| | |
|---|---|
| (1) | Instruments |
| (2) | Singing |
| (3) | Other Music |

| | |
|---|---|
| xiii. | Parenting |
| xiv. | Pets |

| | |
|---|---|
| (1) | Dog Training |
| (2) | Other |

| | |
|---|---|
| xv. | Photography |
| xvi. | Shooting |

| | |
|---|---|
| (1) | Concealed Carry |
| (2) | Tactical |
| (3) | Other Shooting |

| | |
|---|---|
| xvii. | Speaking |
| xviii. | Sports |

| | |
|---|---|
| (1) | Baseball |
| (2) | Boxing |
| (3) | Golf |
| (4) | Martial Arts |
| (5) | Soccer |
| (6) | Swimming |
| (7) | Other Sports |

| | |
|---|---|
| i. | Technology |
| j. | Unique Classes |
| k. | Dispensaries |

| | |
|---|---|
| i. | Dispensaries |

| | |
|---|---|
| (1) | Unique |
| (2) | CBD Shops |
| (3) | Marijuana Doctors |
| (4) | Smoke & Vape Shops |
| (5) | Fast Food Chains |

| | |
|---|---|
| l. | Drive & Ride |

| | |
|---|---|
| i. | Parks & Rides |

| | |
|---|---|
| (1) | Amusement Parks |
| (2) | Bungee Jumps |
| (3) | Carnival Rides |
| (4) | Mechanical Bulls |
| (5) | Observation Rides |
| (6) | Roller Coasters |
| (7) | Water Parks |
| (8) | Zip Lines |

| | |
|---|---|
| ii. | In the Sky |

| | |
|---|---|
| (1) | Airplanes & Gliders |
| (2) | Helicopters |
| (3) | Hot Air Balloons |
| (4) | Skydiving |

| | |
|---|---|
| iii. | On the Land |

| | |
|---|---|
| (1) | ATVs & Dune Buggies |
| (2) | Camels & Horses |
| (3) | Go-Karts & Segways |
| (4) | Land Moving & Sailing |
| (5) | Motorcycles |
| (6) | Off Road Vehicles |
| (7) | Race & Sports Cars |
| (8) | Trains & Rails |

| | |
|---|---|
| iv. | On the Water |

| | |
|---|---|
| (1) | Boats & Jet Skis |
| (2) | Canoes & More |

| | |
|---|---|
| m. | Fitness & Sports |

| | |
|---|---|
| i. | Fitness |

| | |
|---|---|
| (1) | Biking |
| (2) | Boot Camps |
| (3) | Fitness Centers |
| (4) | Fitness Trails |
| (5) | Hiking |
| (6) | Walking & Jogging |
| (7) | Wellness Centers |
| (8) | Yoga & Pilates |

| | |
|---|---|
| ii. | Climbing |

| | |
|---|---|
| (1) | Indoor Climbing |
| (2) | Outdoor Climbing |

| | |
|---|---|
| iii. | Combat Sports |

| | |
|---|---|
| (1) | Boxing |
| (2) | Fencing |
| (3) | Martial Arts & UFC |
| (4) | Wrestling |

| | |
|---|---|
| iv. | Golf |

| | |
|---|---|
| (1) | Executive & Par 3 |
| (2) | Instruction & Fitting |
| (3) | Practice Facilities |
| (4) | Private Golf |
| (5) | Public Golf |
| (6) | Unique Golf |

| | |
|---|---|
| v. | Team Sports |

| | |
|---|---|
| (1) | Baseball |
| (2) | Basketball |
| (3) | Football |
| (4) | Lacrosse |
| (5) | Soccer |
| (6) | Softball |
| (7) | Volleyball |
| (8) | Wallyball |

| | |
|---|---|
| vi. | Racquet Sports |

| | |
|---|---|
| (1) | Badminton |
| (2) | Handball |
| (3) | Paddle Tennis |
| (4) | Pickleball |
| (5) | Private Tennis |
| (6) | Public Tennis |
| (7) | Racquetball |
| (8) | Squash |

| | |
|---|---|
| vii. | Water Sports |

| | |
|---|---|
| (1) | Indoor Pools |
| (2) | Outdoor Pools |
| (3) | Lakes & Rivers |

| | |
|---|---|
| viii. | Winter Sports |

| | |
|---|---|
| (1) | Cross-Country |
| (2) | Ice Skating |
| (3) | Ski & Snowboard |
| (4) | Snowmobiling |
| (5) | Snowshoeing |

| | |
|---|---|
| ix. | Other Sports |

| | |
|---|---|
| (1) | Billiards |
| (2) | Bocce Ball |
| (3) | Bowling |
| (4) | Gymnastics |
| (5) | Horseshoe |
| (6) | Roller Sports |
| (7) | Skate Parks |
| (8) | Trampolines |

| | |
|---|---|
| n. | Games & VR |

| | |
|---|---|
| i. | Games |

| | |
|---|---|
| (1) | Arcades & Barcades |
| (2) | Carnival Games |
| (3) | Escape Rooms |
| (4) | eSports |
| (5) | Rage Rooms |
| (6) | Scavenger Hunts |
| (7) | Unique Games |

| | |
|---|---|
| ii. | Virtual Reality |

| | |
|---|---|
| (1) | Virtual Reality |

| | |
|---|---|
| o. | Health & Beauty |

| | |
|---|---|
| i. | Chiropractic |
| ii. | Cosmetic Dentistry |
| iii. | Cryotherapy |
| iv. | Eyebrows & Eyelashes |
| v. | Hair Salons |
| vi. | Hair Removal |
| vii. | Makeup |
| viii. | Massages |
| ix. | Medical Spas |
| x. | Men's Grooming |
| xi. | Nail Salons |
| xii. | Spas |
| xiii. | Tanning |
| xiv. | Tattoos & Piercing |

| | |
|---|---|
| p. | Public Places |

| | |
|---|---|
| i. | Parks |

| | |
|---|---|
| (1) | Dog Parks |
| (2) | Local Parks |
| (3) | National Parks |
| (4) | State Parks |

| | |
|---|---|
| ii. | Destinations |

| | |
|---|---|
| (1) | Grand Canyon |
| (2) | Hoover Dam |
| (3) | Red Rock |
| (4) | Vegas |
| (5) | Other Destinations |

| | |
|---|---|
| iii. | Other Public Places |

| | |
|---|---|
| (1) | Community Centers |
| (2) | Gardens & Preserves |
| (3) | Libraries |
| (4) | Senior Centers |

| | |
|---|---|
| q. | See |

| | |
|---|---|
| i. | Animals |

| | |
|---|---|
| (1) | Aquariums |
| (2) | Habitats & Zoos |

| | |
|---|---|
| ii. | Entertainment |

| | |
|---|---|
| (1) | Acts & Shows |
| (2) | Movie Theaters |
| (3) | Vegas TV Shows |
| (4) | Watch Your Team or Sport |

| | |
|---|---|
| iii. | Exhibits & Museums |

| | |
|---|---|
| (1) | Art Exhibits |
| (2) | Car Exhibits |
| (3) | Celebrity Exhibits |
| (4) | Motorcycle Exhibits |
| (5) | Museums |

| | |
|---|---|
| iv. | Signs & Statues |

| | |
|---|---|
| (1) | Signs |
| (2) | Statues |

| | |
|---|---|
| v. | Unique See |

| | |
|---|---|
| (1) | Observation Views |
| (2) | Unique Destinations |
| (3) | Vegas Records |

| | |
|---|---|
| r. | Shopping |

| | |
|---|---|
| i. | Big Box Stores |
| ii. | Cigar Shops |
| iii. | Farmer's Markets |
| iv. | Flea Markets |
| v. | Grocery Stores |
| vi. | Liquor Stores |
| vii. | Smoke & Vape Shops |
| viii. | Souvenir Shops |
| ix. | Unique Shops |
| x. | Malls |

| | |
|---|---|
| (1) | Luxury Malls |
| (2) | Outlet Malls |
| (3) | Shopping Malls |

| | |
|---|---|
| s. | Special Occasions |

| | |
|---|---|
| i. | Shops & Services |

| | |
|---|---|
| (1) | Bridal Shops |
| (2) | Florists |
| (3) | Formal Wear |
| (4) | Limos |
| (5) | Photographers |
| (6) | Wedding Licenses |
| (7) | Wedding Planners |

| | |
|---|---|
| ii. | Receptions |

| | |
|---|---|
| (1) | Bartenders |
| (2) | Catering |
| (3) | Entertainment |
| (4) | Rehearsal Dinners |
| (5) | Venues |

| | |
|---|---|
| iii. | Weddings & Ceremonies |

| | |
|---|---|
| (1) | Chapel Weddings |
| (2) | Destination Weddings |
| (3) | Hotel Weddings |
| (4) | Landmark Weddings |
| (5) | Unique Weddings |
| (6) | Other Ceremonies |

| | |
|---|---|
| t. | Tours |

| | |
|---|---|
| i. | New |
| ii. | Unique |
| iii. | Destinations |

| | |
|---|---|
| (1) | Grand Canyon |
| (2) | Hoover Dam |
| (3) | Red Rock |
| (4) | Vegas |
| (5) | Other Destinations |

| | |
|---|---|
| iv. | Length |

| | |
|---|---|
| (1) | Multi-Day |
| (2) | Single-Day |

| | |
|---|---|
| v. | Type |

| | |
|---|---|
| (1) | Bus |
| (2) | Helicopter |
| (3) | Other Tour Types |

| | u. | Wild & Crazy |
|---|---|---|
| 2. | Bars, Clubs, & Drinks | |
| | a. | Featured |
| | b. | New |
| | c. | Bars, Clubs, & Drinks NearMe |
| | d. | Unique |
| | e. | Clubs |

| | |
|---|---|
| i. | Alternative Clubs |
| ii. | Day Clubs |
| iii. | Mega Clubs |
| iv. | Night Clubs |
| v. | Night Swims |
| vi. | After Hours |
| vii. | DJs |
| viii. | Day Club Crawls |
| ix. | Night Club Crawls |

| | |
|---|---|
| f. | Music Types |

| | |
|---|---|
| i. | Country |
| ii. | EDM |
| iii. | Hip-Hop |
| iv. | Open Format |

| | |
|---|---|
| g. | Strip Clubs |

| | |
|---|---|
| i. | Gentlemen's Clubs |
| ii. | Male Strip Clubs |

| | |
|---|---|
| h. | Bars & Lounges |

| | |
|---|---|
| i. | Barcades |
| ii. | Billiards Bars |
| iii. | Cigar Bars |
| iv. | Dive Bars |
| v. | Fine-Dining Bars |
| vi. | Fireplace Bars |
| vii. | Flair Bars |
| viii. | Hookah Lounges |
| ix. | Karaoke Bars |
| x. | LGBTQ Bars |
| xi. | Piano Bars |
| xii. | Restaurant Bars |
| xiii. | Sports Bars |
| xiv. | Tiki Lounges |
| xv. | Ultra Lounges |
| xvi. | Unique Bars |
| xvii. | Watch Your Team Sport |

| | |
|---|---|
| (1) | Watch your Team/Sport |

| | |
|---|---|
| (a) | NFL |

| | |
|---|---|
| (i) | Las Vegas Raiders |
| | 1) Raiders Live at Allegiant Stadium |
| | 2) Raiders Broadcast/Online |
| | 3) Raiders Watch Parties |
| (i) | NFL Team Bars |
| (ii) | NFL Team Restaurants |

| | |
|---|---|
| (b) | UFC |

| | |
|---|---|
| (i) | UFC Live |
| (ii) | UFC Online |
| | 1) ESPN+ |
| | 2) UFC Fight Pass |
| | 3) UFC PPV |
| (iii) | UFC Watch Parties |

| | |
|---|---|
| i. | Beer, Liquor, & Wine |

| | |
|---|---|
| i. | Breweries |
| ii. | Distilleries |
| iii. | Liquor Stores |
| iv. | Wine Tasting |

| | |
|---|---|
| j. | Non-Alcoholic Drinks |

| | |
|---|---|
| i. | Coffee & Tea |
| ii. | Juice & Smoothies |

| 3. | Gambling | |
|---|---|---|
| | a. | Featured |
| | b. | New |
| | c. | Gambling NearMe |
| | d. | Unique |
| | e. | Live Gambling |

| | |
|---|---|
| i. | Baccarat |
| ii. | Blackjack |
| iii. | Bingo |
| iv. | Craps |
| v. | Keno |
| vi. | Pai Gow Poker |
| vii. | Poker Rooms |
| viii. | Roulette |
| ix. | Slots |
| x. | Sportsbooks |
| xi. | Video Poker |
| xii. | Other Table Games |

| | |
|---|---|
| f. | Online Gaming |

| | |
|---|---|
| i. | Fantasy Sports |
| ii. | Online Poker |
| iii. | Online Slots |
| iv. | Online Sports |

| 4. | Restaurants | |
|---|---|---|
| | a. | Featured |
| | b. | New |
| | c. | Restaurants NearMe |
| | d. | Unique |
| | e. | Restaurant Chains |

| | |
|---|---|
| i. | Fast Food |
| ii. | Casual |
| iii. | Upscale |

| | |
|---|---|
| f. | Cuisines & Styles |

| | |
|---|---|
| i. | Styles |

| | |
|---|---|
| (1) | Fast Food |
| (2) | Casual Dining |
| (3) | Fine Dining |
| (4) | Buffets |
| (5) | Family Style |
| (6) | Fast Casual |
| (7) | Food Trucks |

| | |
|---|---|
| ii. | Asian |

| | |
|---|---|
| (1) | Chinese |
| (2) | Filipino |
| (3) | Indian |
| (4) | Japanese |
| (5) | Korean |
| (6) | Thai |
| (7) | Vietnamese |
| (8) | Other Asian |

| | |
|---|---|
| iii. | European |

| | |
|---|---|
| (1) | French |
| (2) | Greek |
| (3) | Italian |
| (4) | Mediterranean |
| (5) | Spanish |
| (6) | Other European |

| | |
|---|---|
| iv. | North American |

| | |
|---|---|
| (1) | BBQ |
| (2) | Burgers |
| (3) | Chicken |
| (4) | Cuban |
| (5) | Hawaiian |
| (6) | Mexican |
| (7) | Pizza |
| (8) | Sandwich & Sub |
| (9) | Seafood |
| (10) | Soup & Salad |
| (11) | Southern |
| (12) | Steak |
| (13) | Other American |

| | |
|---|---|
| v. | Other |

| | |
|---|---|
| (1) | South American |
| (2) | Middle Eastern |
| (3) | African |
| (4) | Other Cuisines |

| | |
|---|---|
| g. | Features |

| | |
|---|---|
| i. | Celebrity Chef |
| ii. | Late Night |
| iii. | Live Music |
| iv. | Romantic |
| v. | Scenic View |
| vi. | Fun for Dogs |
| vii. | Fun for Groups |
| viii. | Fun for Kids |

| | |
|---|---|
| h. | Specialties |

| | |
|---|---|
| i. | Bakeries |
| ii. | Breakfast & Brunch |
| iii. | Coffee & Tea |
| iv. | Desserts & Sweets |
| v. | Juice & Smoothies |
| vi. | Seafood |
| vii. | Steakhouses |
| viii. | Sushi Bars |
| ix. | Tapas |
| x. | Teppanyaki |
| xi. | Vegan & Vegetarian |

| 5. | Places | |
|---|---|---|
| | a. | Featured |
| | b. | New |
| | c. | Places NearMe |
| | d. | Popular |
| | e. | Unique |
| | f. | Arenas & Stadiums |
| | g. | Convention Centers |
| | h. | Resorts |
| | i. | Shopping Malls |
| 6. | Shows & Events | |
| | a. | Featured |

| | |
|---|---|
| i. | Free |
| ii. | NearMe |
| iii. | New |

| | |
|---|---|
| b. | Free |
| c. | Shows & Events NearMe |
| d. | New |
| e. | Unique |
| f. | Residencies |
| g. | Comedy |
| h. | DJs |
| i. | Fun for Kids |
| j. | Magic |
| k. | Music |

| | |
|---|---|
| i. | Alternative |
| ii. | Blues |
| iii. | Country |
| iv. | Cover Bands |
| v. | Dance & Electronic |
| vi. | Folk |
| vii. | Hip-Hop & Rap |
| viii. | Jazz |
| ix. | Latin |
| x. | Metal |
| xi. | Pop |
| xii. | R&B |
| xiii. | Reggae |
| xiv. | Rock |
| xv. | Other |

| | |
|---|---|
| l. | Popular |
| m. | Sports |
| n. | Theater |
| o. | Variety |
| p. | Major Events |
| q. | Adult Shows |

| | |
|---|---|
| i. | Female Reviews |
| ii. | Male Reviews |
| iii. | Other Adult |

| | r. | Theater Maps |
|---|---|---|
| 7. | Podcasts & Videos | |
| | a. | Featured |
| | b. | New |
| | c. | Popular |
| | d. | General Vegas |
| | e. | Golden Knights |
| | f. | Las Vegas Raiders |
| | g. | UNLV |
| | h. | Gambling |

| | |
|---|---|
| i. | Poker |
| ii. | Sports |
| iii. | Other Gambling |

| 8. | Medical | |
|---|---|---|
| | a. | Open Nearest You |

| | |
|---|---|
| i. | Emergency Room |
| ii. | Urgent Care |
| iii. | Emergency Dental |
| iv. | Veterinary Emergency |
| v. | CVS |

| | |
|---|---|
| b. | Emergency Rooms |
| c. | Urgent Care |
| d. | Emergency Dental |
| e. | Pet Emergency Care |
| f. | Pharmacies |
| g. | Chiropractic |
| h. | Covid-19 Testing |
| i. | Covid-19 Vaccination |
| j. | CBT Shops |
| k. | Dispensaries |
| l. | Concierge Medicine |
| m. | Drug Stores |

n. TeleHealth Services

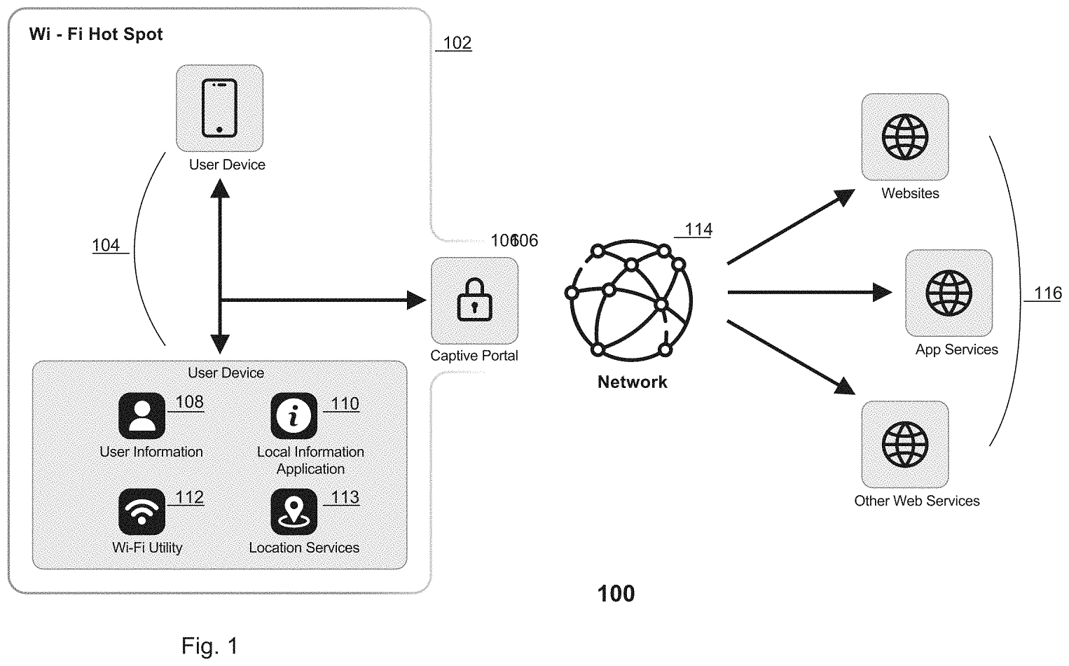

Turning to the network and hardware environment of the invention, FIG. 1 shows a system 100 for accessing and using a Wi-Fi hotspot 102 in accordance with the present invention. The hotspot 102 allows user devices 104, such as mobile telephones, tablet computers, or laptop computers to access portals 116 of a network 114, such as the Internet, via a gateway 106 of the hotspot 102. Such hotspots are often available in hotels, resorts, restaurants, coffee shops, and other facilities. Of particular importance in the context of the present invention, such hotspots are often used by residents and visitors of a location of interest, such as a city or other locality, to access information about local goods and services. That is, Wi-Fi hotspots are often accessed by users who are away from their home or office and are interested in obtaining location about local goods and services.

One difficulty associated with accessing and using a Wi-Fi hotspot in such contexts is the captive portal problem as described above. If a user of a user device 104 attempts to use an application to access a platform 116 for local information, or if the user attempts to use an application to access a platform 116 for other applications, the user will often be frustrated due to failure of such an application to operate properly. Of course, many users set up their devices to automatically access any available hotpots. Therefore, a user's device may access hotspots, and move between hotspots as the user moves about a resort or locality. In many cases, the user will be able to launch or otherwise activate the application but, when the application needs to download information from a platform 116, the application will be unable to download such information. Many users will not understand that this is a captive portal problem. Even users who do understand may have difficulty in overcoming the problem. In the case of a tourist or other visitor of a locality, the visitor may move between resorts, or between hotspots within a given resort, and the problem may recur frequently. Moreover, many hotpots require periodic sign-ins or are set up so that sign-ins expire at a certain time of day. Accordingly, the problem recurs resulting in great frustration. The illustrated system 100 addresses this issue for local information tools and other applications.

The Wi-Fi hotspot 102 includes one or more antennas for communicating with the user devices 104 and a gateway 106. The gateway 106, which may be embodied in a processor-based machine or machines, manages access to the network 114 via the hotspot 102 and executes various connectivity functions. With regard to managing access to the network 114 via the hotspot 102, the gateway may require user devices 104 to enter certain identification information or credentials before allowing access to the network 114. For example, the user devices 104 may be required to enter an email address, a password, or guest information, among other things.

The illustrated user devices 104 generally include a repository of user information 108, one or more tools such as a local information tool 110, a Wi-Fi utility 112, and a location services module 113. The user information 108 may include user identification information, preference information including preferences concerning use of available Wi-Fi hotspots, device attributes, and other information. The local information tool 110, as will be described in detail below, works in conjunction with a local information portal to provide a variety of information regarding local sources of goods and services. The Wi-Fi utility 112 includes hardware and associated logic for accessing and communicating with Wi-Fi hotspots. The location services module 113 is operative to provide information related to the location of the user device 104. Such location information may be from any one or more of a variety of sources such as the Global Positioning System (GPS), wireless networks cell or cell sector information, a hotspot identifier, network triangulation technologies such as time difference of arrival (TDOA) and angle of arrival (AOA) technologies, node tracing, or other positioning technologies.

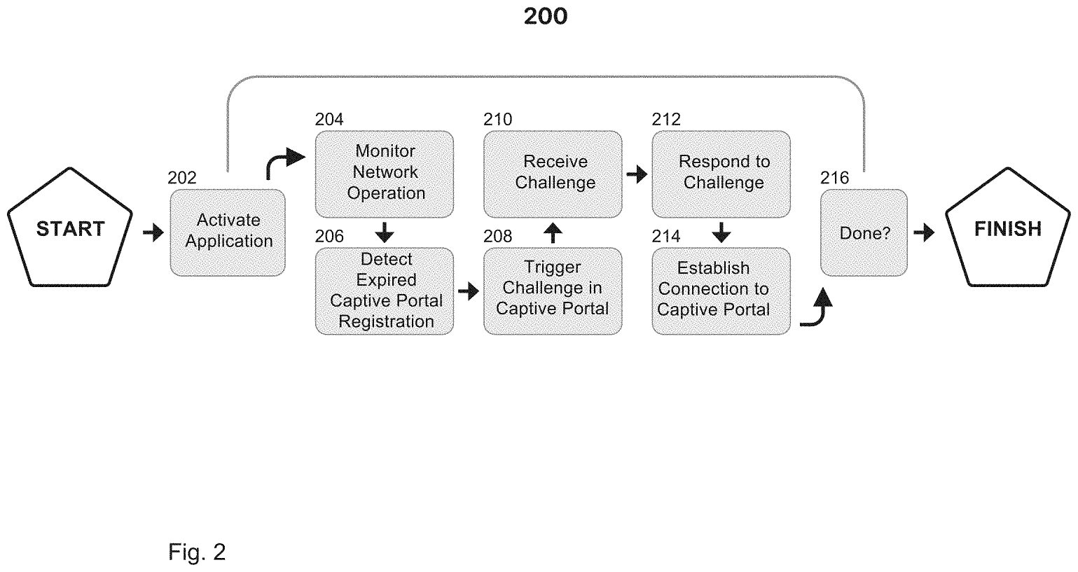

FIG. 2 is a flowchart illustrating an associated process 200. The process 200 is initiated by activating (202) a tool. For example, the user may operate the user device to launch the tool or the tool may begin or continue operation in response to entering a location of the Wi-Fi hotspot. After activation, the device may monitor (204) the operation of the tool to identify a condition that indicates a captive portal issue. In particular, the tool may monitor a request for information to be downloaded from a portal such as a server associated with the tool. If the information requested from the portal is not returned within a defined time, for example, on the order of a few seconds, then the application may detect (206) that a possible captive portal situation exists.

In response, the device may transmit (208) a trip message to the gateway. For example, the device may initiate a call to an outside URL that is designed to trigger a challenge from the gateway. The user device will then receive (210) a challenge from the gateway. For example, the gateway may request that the user device enter identification information or credentials such as an email address, a password, guest information, or respond to a prompt on a login page. The user device or the user may then respond (212) to the challenge. This may require a manual response by the user otherwise an automatic response may be executed by the device. In any event, once the challenge has been satisfied, the tool may establish (214) a connection to the network portal. For example, the tool may access the portal to download application information, e.g., in the case of a local information application, the application may receive search results, mapping information, or the like. If no further information is required from the portal, the process is completed. Otherwise, the tool may continue to monitor operation of the application to detect further gateway failures.

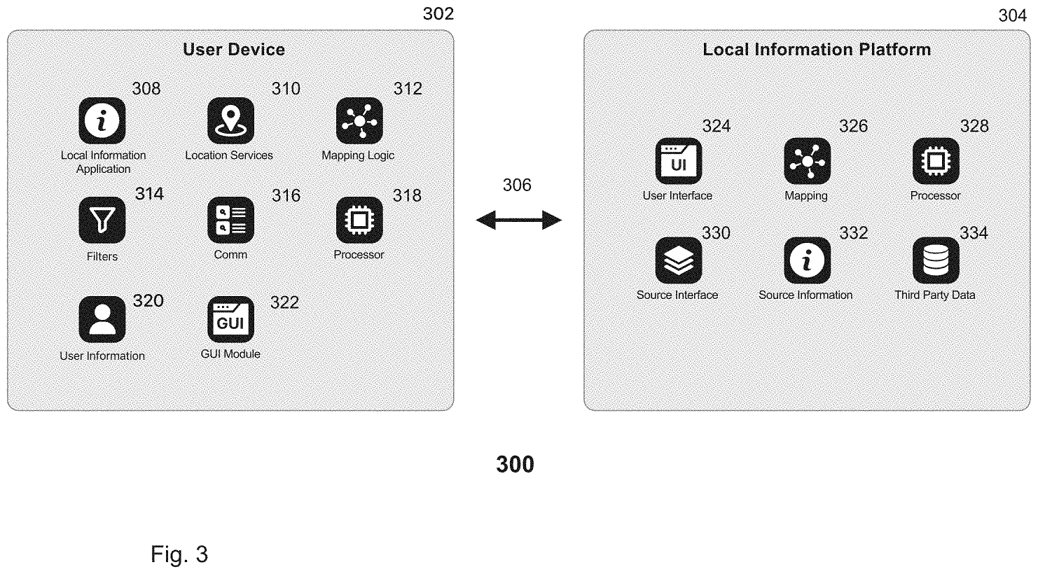

FIG. 3 illustrates in more detail a local information system 300 in accordance with the present invention. The system 300 generally includes a user device 302 and a local information platform 304. As described herein, the user device 302 can access the platform 304 to obtain a variety of information about local services such as: finding local sources of various categories and subcategories of goods and services; filtering the search results to identify sources with particular attributes; obtaining information about the available goods and services; obtaining coupons or information about special offers; obtaining driving and/or walking directions to identified sources; making reservations; obtaining tickets; arranging transportation; and many more. The user device can access the platform 304 via a network connection 306 that may include wireless and/or wireline connections. For example, a user device such as a mobile telephone, tablet computer, laptop computer or the like may utilize a Wi-Fi hotspot to access the platform 304 via the Internet.

A particular implementation of the system 300 is described herein in connection with specific components and functionality executed on the user device 302 and cooperating components and functionality implemented on the platform 304. However, it will be appreciated that the noted components and functionality may be distributed in different ways across the user device 302 and the platform 304. Moreover, the platform 304 may be implemented on one or more machines at a single location or may be geographically distributed. Moreover, although a single user device 302 is illustrated, it will be appreciated that the system 300 may service a very large number of user devices, for example, many thousands or even a million or more user devices in a given locality.

The illustrated user device 302 includes a processor 318 for executing a broad range of functionality and a communications module 316 for communicating with Wi-Fi hotspots, a wireless network, and/or data networks such as the Internet. The processor 318 and communications module 316 may be provided as an integral part of the user device 302, such as a mobile phone, tablet computer, or laptop computer and/or may be modified or supplemented to execute certain functionality of the local information system 300.

The illustrated device 302 further includes a local information tool 308. As will be described in more detail below, the local information tool is operative to access the platform 304, to submit local information requests via defined graphical user interface screens, to receive responsive local information from the platform 304, and to perform a variety of functions related to displaying and filtering the results, among other things. The device 302 further includes a location services module 310 for providing location information regarding the device 302. Location information may be provided in a variety of ways. For example, the location of the user device 302 may be based on GPS information for the device 302, a location of a hotspot being used by the device 302, wireless network location information such as cell or cell sector information, triangulation information such as TDOA or AOA based information, data network information such as node tracing, or any other available location information or combinations thereof. As will be appreciated, the location information provides a basis for identifying local service information, providing distance information relative to identified sources of goods and services, and providing mapping information, e.g., directions to a source of goods and services.

The device 302 further includes mapping logic 312 and filters 314. The mapping logic assists in rendering various maps used for providing directions or graphical displays of locations within a locality or facility. For example, in connection with providing directions to a particular source of goods and services, such as a restaurant, within a larger facility such as a resort or casino, the mapping logic 312 may be operative to obtain, e.g., from the platform 304, a map of the facility including the location of the restaurant within the facility, to obtain from the location services 310 the current location of the device, to render the map of the facility with appropriate identifiers for the location of the restaurant and the location of the device 302, to provide textual and/or graphical directions, and to update directions as the user device 302 progresses towards the destination.

The filters 314 can filter the results of a search concerning local information to identify or emphasize certain subsets of the search results based on defined criteria. While many examples of filters are possible, some examples include filtering the results based on the age of a user of the user device 302, filtering the results based on the location of the user device 302 filtering the results based on various categories and subcategories of goods and services, filtering the results based on user preferences such as loyalty programs, and filtering the results based on specific dates, days of the week, or hours of operation. Accordingly, the filters 314 may receive raw search results from the platform 304 and user preferences or other user information from the user device 302 and execute logic to filter the raw search results to yield an enhanced set of search results.

The local information tool 308 may use a variety of user information 320 to execute various functionality of the system 300. Such user information 320 may include, for example, identification information for the user (e.g., name, address, email addresses, loyalty program account numbers, age, device information, and the like), financial information (e.g., credit card numbers, payment service information, etc.), user preference information (e.g., preferences concerning network access, privacy settings, etc.), and any other information to facilitate operation of the system 300. The illustrated device 302 further includes a GUI module 322 for rendering various graphical user interfaces and processing inputs entered in relation to the interfaces. For example, the module 322 may render display elements for entering dates, numbers, prompts, graphical elements on maps, pulldown screens, menus and the like and may interpret user inputs entered in relation to such elements.

The illustrated platform 304 generally includes a user interface facility 324, a mapping utility 326, a processor 328, a source interface 330, a source information repository 332, and a third-party data repository 334. The processor 328 is operative to access logic and information and to execute the functionality of the platform 304. The processor 328 may be implemented in one or more servers or other data devices. The user interface facility 324 is operative to generate user interfaces that can be rendered on the user devices 302. The user interfaces allow users of the devices 302 to enter selections related to the local information system 300 such as identifying categories and subcategories of goods and services of interest, requesting information regarding the sources, and the like. In this regard, the user interface facility 324 interacts with the device 302 to render user interface screens, receive inputs in relation to user interface screens, and transmit responsive information to the device 302.

The mapping utility 326 supports a variety of functionality relating to mapping features such as showing search results on a map, accessing local maps or facility maps related to search results, and providing driving and/or walking directions. In this regard, the mapping utility 326 may access GIS information, mapping information from particular facilities, and other mapping resources. The source interface 330 allows sources of goods or services to access the platform 304 to enter various kinds of information. For example, individual sources of goods or services may desire to access the platform 304 to update information regarding operating hours, to provide information regarding upcoming shows and events, to enter information regarding promotions or coupons, or to provide logos, advertisements, images and other promotional materials. The source interface 330 provides convenient interfaces for enabling sources to directly input and update such information. The resulting information, as well as information regarding sources input by system administrators or accessed from other sources may be stored in the source information database 332.

The illustrated platform 304 also includes a repository 334 of third-party data. Such third-party data may be used to support a variety of other services in connection with the system 300. For example, such third-party data 334 may be used to organize sources of goods and services by chain, to group sources that are part of a common loyalty program or system, to obtain business or ratings information regarding individual sources of goods and services, to access information regarding weather forecasts and other environmental information, to access traffic and driving time information, and any other information useful in generating or enhancing local service information. Although illustrated as a data repository 334, such third-party information may be accessed, at least in part, in real time in connection with replying to requests by user devices 302.

It will be appreciated that the local information system 300 involves a large amount of data concerning goods and services, as well as associated vendors and venues, in the locality covered by the system, e.g., a metropolitan area such as the Las Vegas, Nev. metropolitan area. For example, within a given category, e.g., “Restaurants,” information may be compiled for many, or substantially all, restaurants in the locality. For each restaurant, various fields of information may be collected or assigned such as, for example, name, location, address, phone number, cuisine type, hours of operation, a text description of the restaurant, and various attributes such as categories (fast food, fine dining, etc.), dining options (eat-in, carry-out, etc.), availability of outdoor seating, celebrity chef, etc. Moreover, some attributes may be related to attributes of associated data collections. For example, some attributes may be inherited from a parent, grandparent (and so on) data objects, e.g., a particular restaurant may be located in the Grand Canal Shoppes at the Venetian Resort in Las Vegas. Thus, for example, location information for the restaurant may be “inherited” from existing location information for the Canal Shoppes or for the Venetian Resort. Similarly, certain information for a child object may be imputed to a parent, grandparent (or the like) data object.

This data is compiled and used in various ways in the local information system 300. First, the information is compiled for use on the local information platform 304 of the system 300. This may involve a substantial effort in accessing available information sources, uploading location information, obtaining data entered by vendors or others via a vendor portal, and assigning categories and attributes, among other things. It is desirable that this data compiling and updating is easy and efficient. Then, during use, portions of this data may be downloaded to user devices. Such downloads are preferably fast and readily accommodated within network bandwidth constraints and processing limitations. It is therefore important to define a data structure that is compact, uniform, and efficient, and that promotes propagation through the system.

A first data structure is employed for data that is compiled and stored on the platform 304. The data structure may be the same as or different than a data structure employed to extract portions of the data from the platform 304 for delivery to the user devices. For example, it may be desired to employ compact data representations, e.g., of operating hours, location, or the like, for transferring data to user devices for improved bandwidth utilization and processing speed. In such cases, appropriate logic may be employed to translate, or re-format data extracted from the platform 304 for transmission to the user devices.

Generally, the data stored on the platform 304 includes all of the data for the goods and services of the relevant locality as well as the metadata that defines the data as well as categories and relationships of the items of data. For example, the data may be stored in tables, where each table includes certain defined fields. Thus, the “Activities” table may include fields such as “activity type,” “activity time,” “price range,” and the like. Various data types are associated with the individual fields such as text string, integer, Boolean (e.g., true, false), datetime, and index. The tables collectively define a complete and yet compact dataset for each category.

FIG. 48 shows a synched data model used to send data to logic running on user devices via a synching database service. Specifically, FIG. 48 provides an entity relationship diagram showing the relationship between logical entities such as “venue,” “activity,” and “activity category.” Within each entity, fields are indicated by a field identifier (e.g., “places” or “location”) and a data type (e.g., “Bool” for Boolean or “string”). Optional fields are indicated by question marks.

Relationships between entities are indicated by the lead lines terminating with symbols. The symbols include a circle to indicate zero relationships or connections, a line to indicate one relationship or connection, and feet to indicate many connections or relationships. Thus, a venue can relate to zero to many activities whereas an activity can relate to zero or one venues.

Within particular fields, custom formats may be used for enhanced efficiency. Thus, for example, the “Business Hours...” fields may use a custom string format to efficiently communicate the business hours from the stored format in the platform 304 to the logic of the user device 302. In this manner, the user devices can efficiently receive and render information from the platform 304 responsive to requests from the user devices.

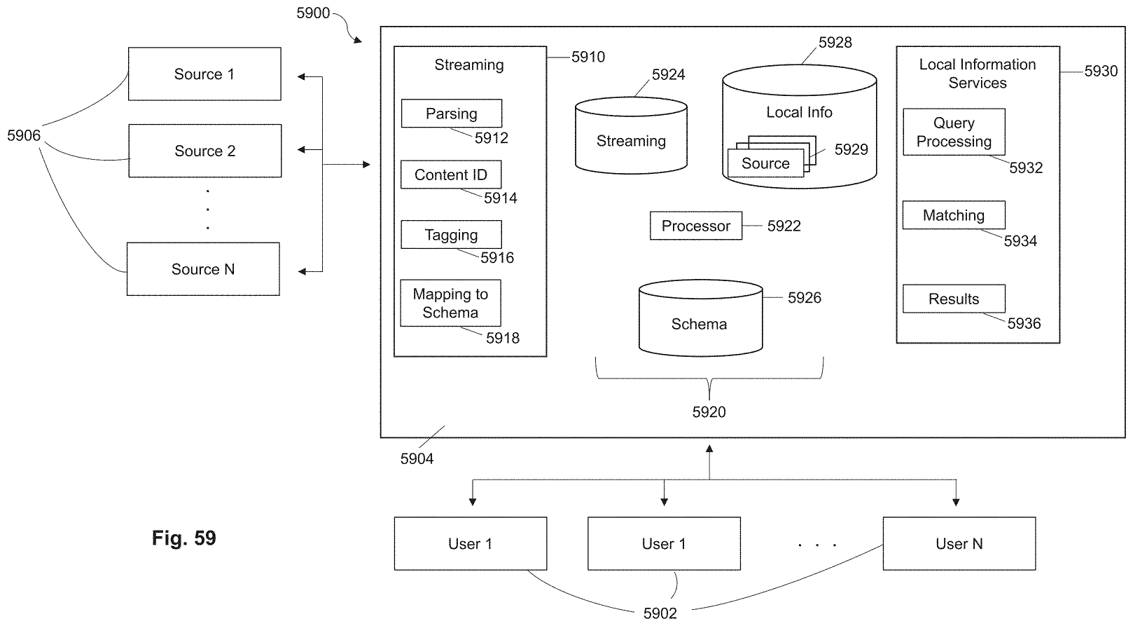

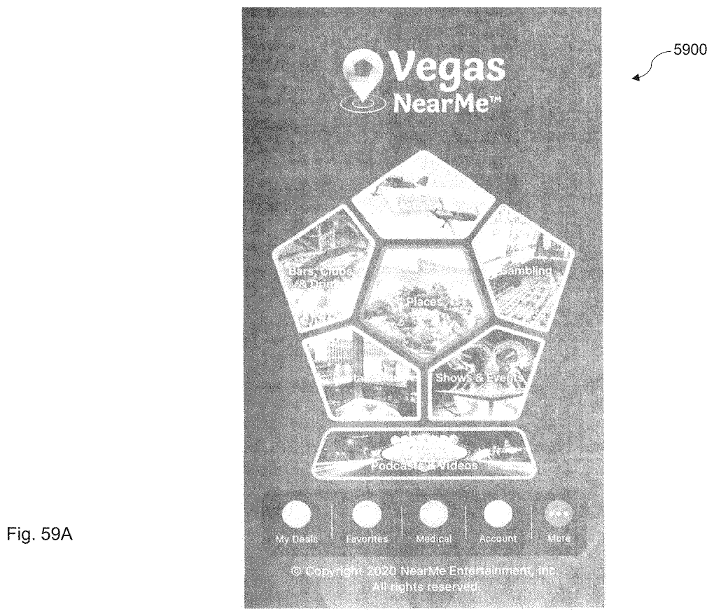

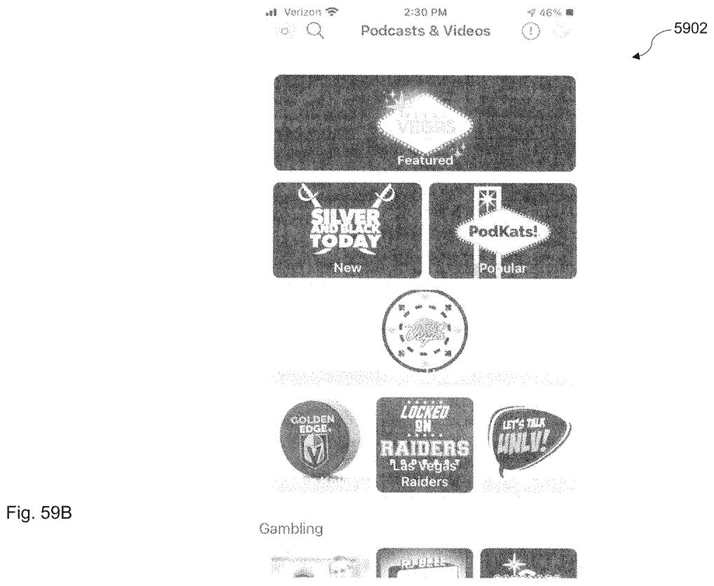

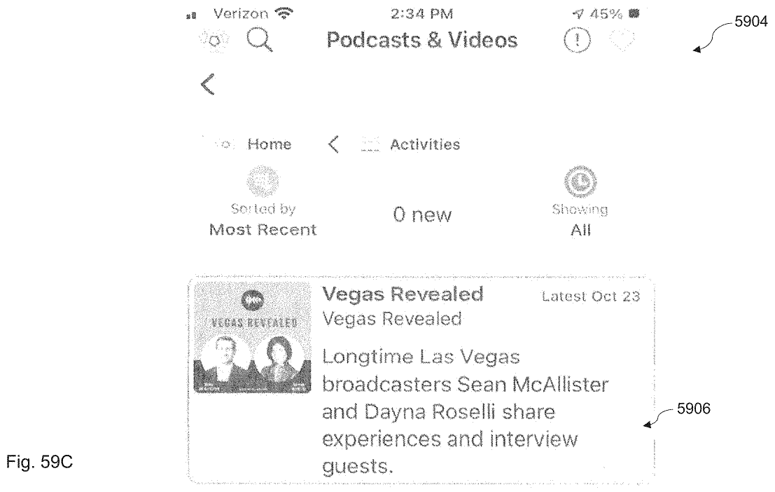

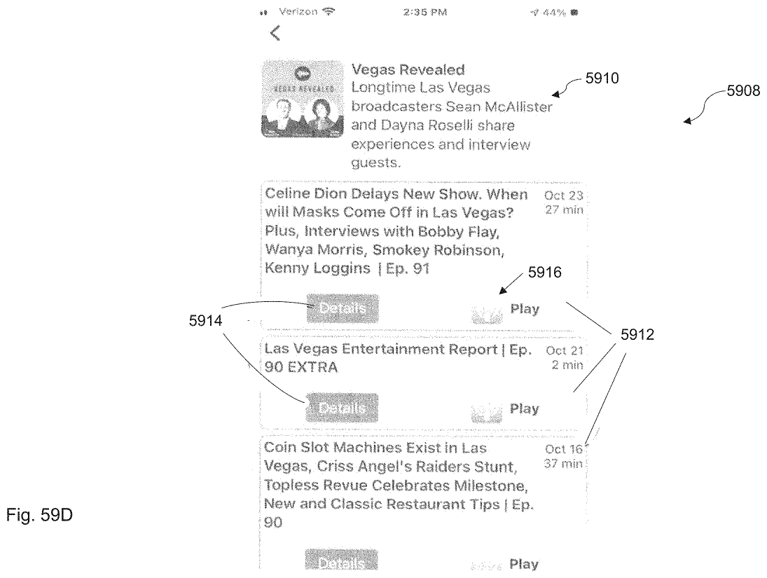

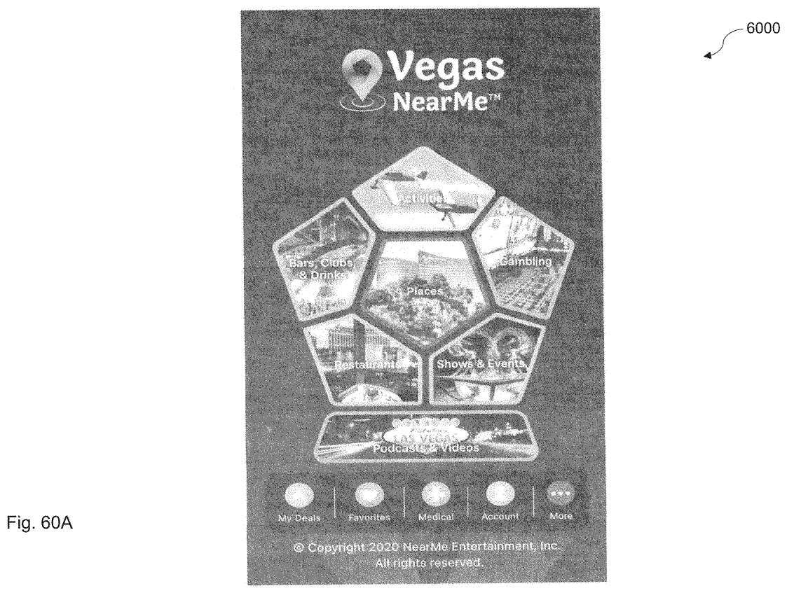

FIGS. 59A-59D show a series of user interface screens that illustrate functionality for accessing relevant streaming information in accordance with the present invention. For example, the streaming information may include podcasts, video content, or other content having an audio and/or video component. In the following description, this functionality is set forth in the context of a local information system. That is, a user can use a local information system application to search for information regarding providers of goods and services in the vicinity of a location associated with a user (e.g., the user's current location or another location specified by the user). However, it will be appreciated that the functionality described below can be used to directly access relevant podcast information. For example, relevant podcast information may be retrieved and provided to a user directly in response to a search request as opposed to associating relevant podcasts with local goods or services information as described in the example below.

Referring to FIG. 59A a user can initiate a search process from a home screen 5900 as shown. As discussed above, such a home screen may provide categories from which the user can select such as activities, restaurants, and podcasts and videos among others. FIG. 59B shows a user interface screen 5902 that may be displayed upon selecting the podcasts and videos category from the interface screen 5900. The interface screen 5902 provides categories of podcasts and videos that may be selected by a user such as featured, new, and popular, among others. FIG. 59C shows a user interface screen 5904 that may be presented upon selection of the featured category from user interface screen 5902. The user interface screen 5904 may present one or more items of streaming content associated with the selected category of podcasts and videos. In this case, a single podcast information item 5906 is provided for the category “featured.”

FIG. 59D shows a user interface screen 5908 that may be presented upon selection of the information item 5906 of the user interface screen 5904. The illustrated screen 5908 includes a first information item 5910 concerning the item 5906 from user interface screen 5904. The information item 5910 may be the same as or different from the information item 5906. User interface screen 5908 also includes additional information items 5912 concerning other relevant streaming content. As will be understood from the description below, these additional information items 5912 may be selected because they include one or more segments that are relevant to the selected item 5910. The illustrated items 5912 each include a button 5914 that may be selected to obtain additional information concerning the respective item 5912 and a button 5916 that may be selected to initiate playback of the relevant streaming content. For example, the streaming content may be played from the beginning of the streaming content or playback may be initiated at the relevant segment. In this regard, the information item 5912 may include buttons to allow user to select playback from the beginning or from the relevant segment, or user may be given an option to select playback from the beginning or from the relevant segment upon selecting the button 5916.

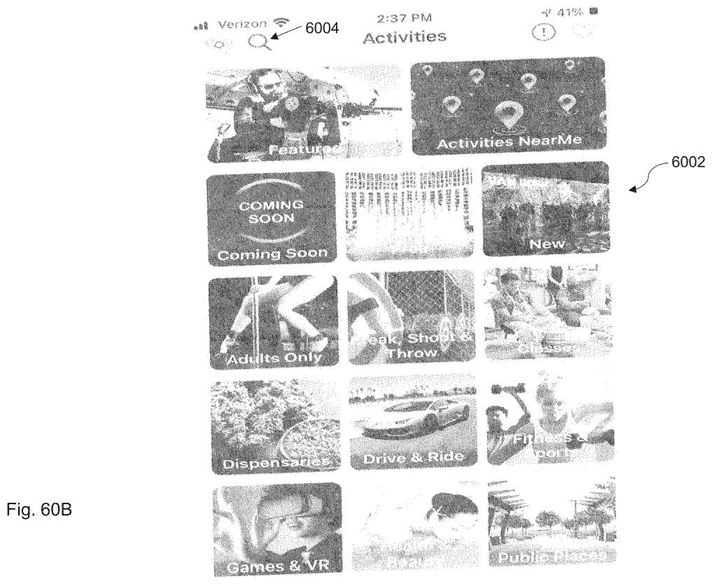

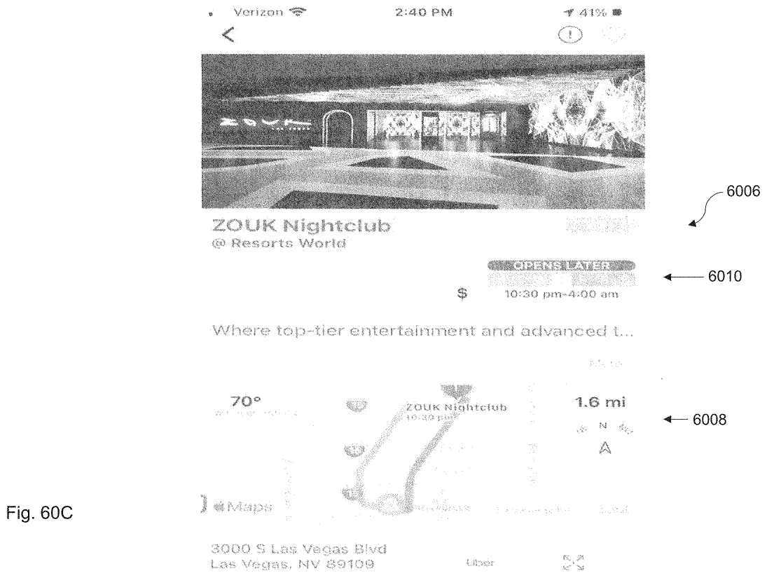

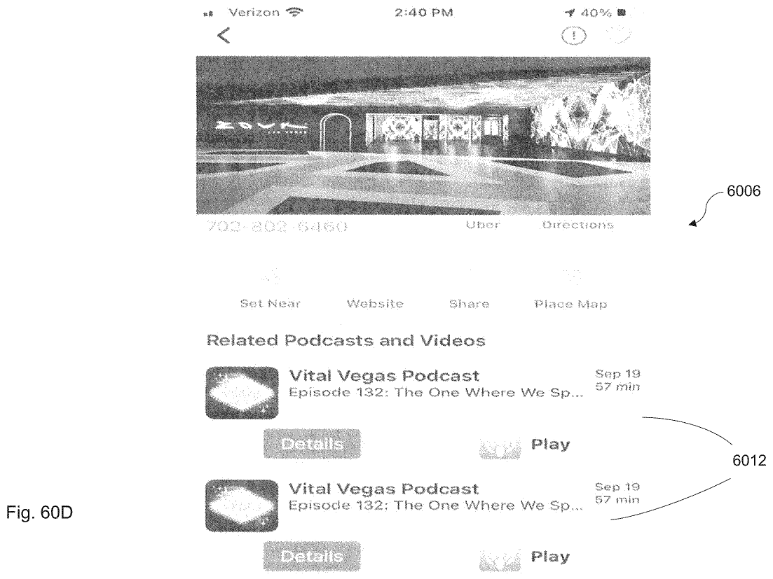

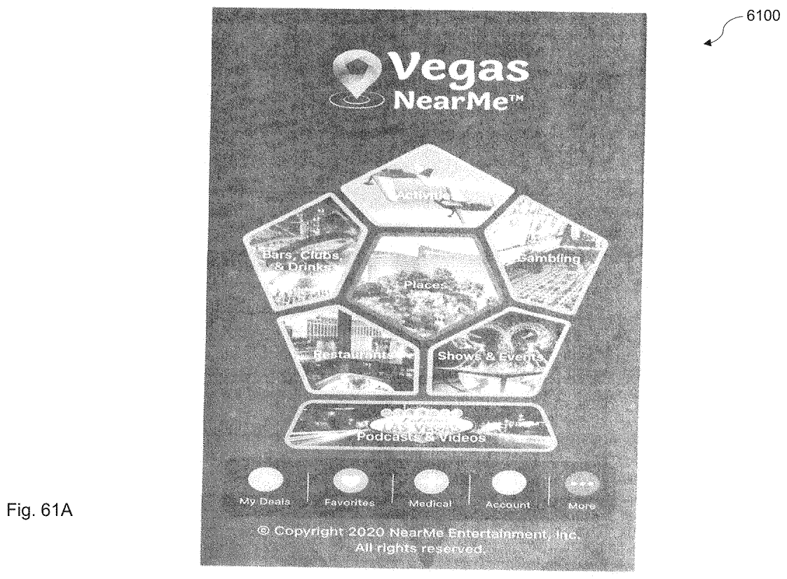

FIGS. 60A-60D show another series of user interface screens illustrating functionality for accessing relevant streaming information in accordance with the present invention. A corresponding process may be initiated from a home interface screen 6000 where a user can select from categories of local goods, services, and information. FIG. 60B shows a user interface screen 6002 that may be presented upon selecting the activities category from the interface screen 6000. As shown, the interface screen 6002 allows a user to select from various categories of activities in the proximity of a location associated with the user. The user may select one of these categories or may use the search icon 6004 to search for activities based on a search term or other expression.

FIGS. 60C-60D shows the top and bottom portions, respectively, of a user interface screen 6006 that may be presented after the user selects the search icon 6004 of the interface screen 6002 and enters the search term “Zouk.” The top portion of the user interface screen 6006 presents a variety of information as described above including a map 6008 and operating hours information 6010. The bottom portion of the user interface screen 6006 presents a number of information items 6012 concerning streaming content that is relevant to the search results, in this case, the “Zouk Nightclub.” For example, the information items 6012 may concern streaming content where the nightclub was mentioned, where information about nightclubs is discussed, or that is otherwise relevant to the nightclub. Again, each of the information items 6012 includes buttons for obtaining additional information about the streaming content or to initiate playback of the streaming content, either from the beginning or from the relevant portion.

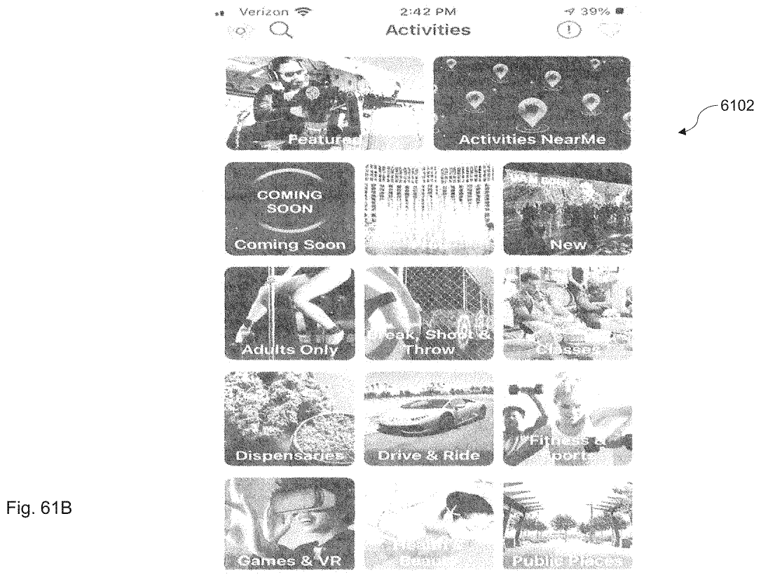

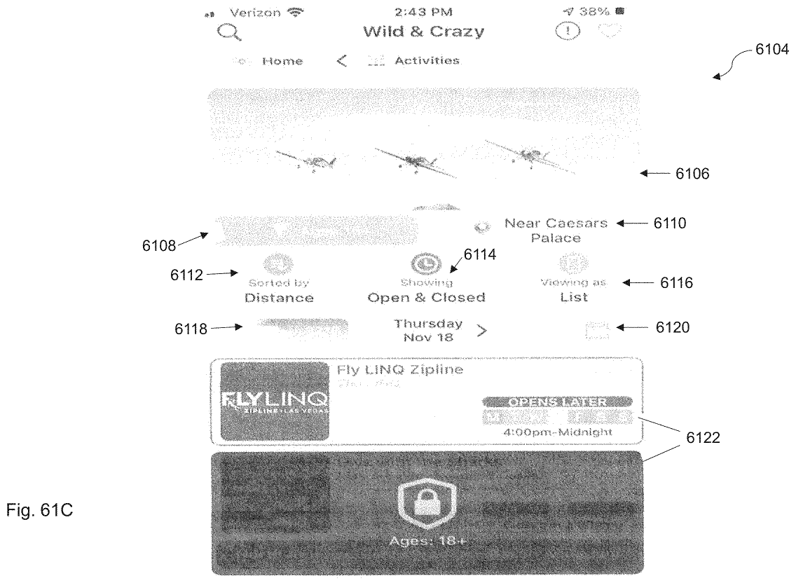

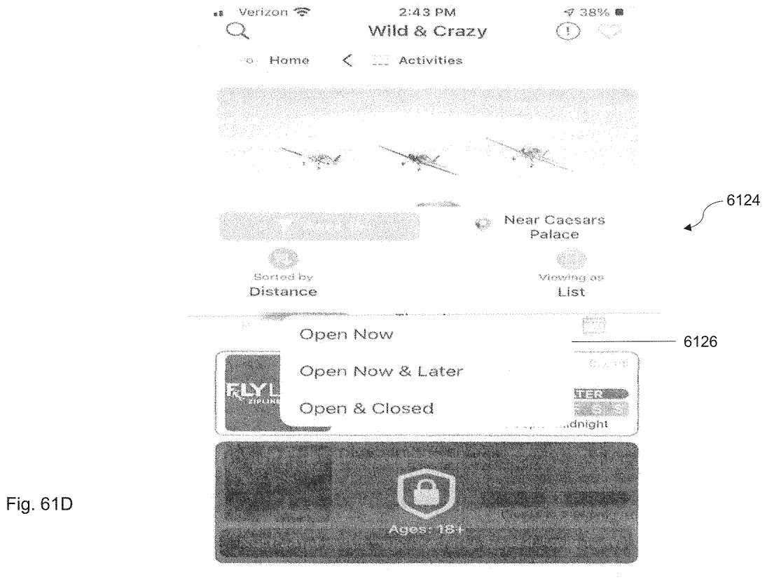

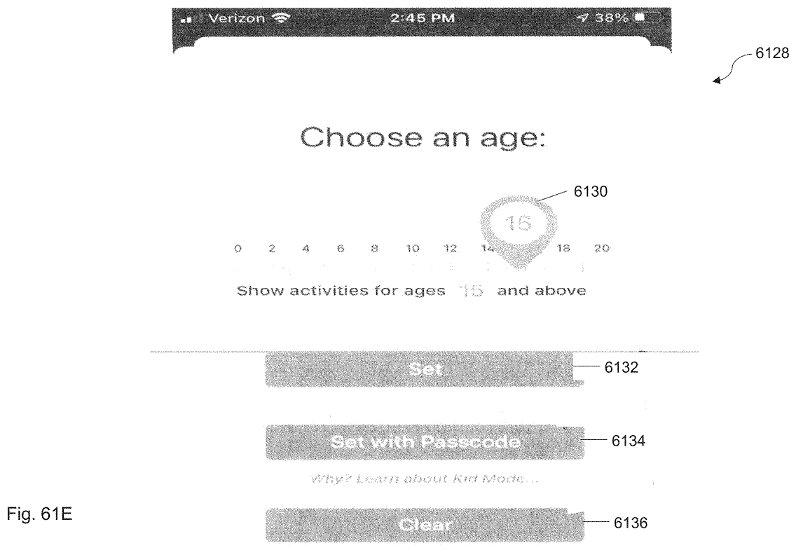

FIGS. 61A-61E show a further series of user interface screens illustrating functionality for accessing relevant streaming content and associated features in accordance with the present invention. FIG. 61A shows a home user interface screen 6100 as described above where the user can select categories of activities from the interface screen 6100 concerning local goods, services, and information. FIG. 61B shows a user interface screen 6102 that may be presented upon selecting the activities category from the home screen 6100. The user can select from among various categories of activities displayed on the screen 6102. FIG. 61C shows a user interface screen 6104 that may be presented upon selection of the wild and crazy category from the user interface screen 6102 (which category is presented in a lower portion of user interface screen 6102 not shown in FIG. 61B).

The user interface screen 6104 illustrates features of the local information system in which the streaming content functionality is implemented. The illustrated screen 6104 includes: an image 6106 representative of the category; an age filter button 6108 as will be described in more detail below; a location filter button 6110 that can be used to filter the results in relation to a current location of the user, a specified location of the user, an address, or the like; a sorting button 6112 that may be used to sort the search results by, for example, distance or name; a showing button 6114 as will be described in more detail below; and a viewing button 6116 that allows the user, for example, to toggle between viewing the results as a list or viewing the results as a map. The illustrated screen 6104 also includes a panel 6118 for providing weather information and a panel 6120 for selecting the date of interest. In this regard, the date of interest may be the current date, or another date selected by the user using the panel 6120. Finally, the screen 6104 includes information items 6122 as generally described above. As shown, one or more information items 6122 may be shaded or blackened, as being prohibited by the age filter, or such items 6122 may simply be omitted from the displayed results.

FIG. 61D shows a user interface screen 6124 including a pulldown menu 6126 that may be displayed upon selecting the showing button 6114 of screen 6104. The pulldown menu 6126 allows the user to select filtering options for the displayed results including establishments that are open now, establishments that are open now and later and all responsive establishments whether open or closed. It will be appreciated that the user may prefer one of these filter selections depending on whether the user is planning to immediately patronize an establishment, planning to patronize an establishment later in the day, or simply interested in information about establishments.

FIG. 61E shows a user interface screen 6128 that may be presented upon selection of the age filter button 6108 of user interface screen 6104. The illustrated screen 6128 includes a selection icon 6130 that can be dragged and dropped to a desired age displayed on the age scale. The set button 6132 can be selected to set the age filter at the age selected using the icon 6130. The set with passcode button 6134 can be used to set an age filter with a passcode so that the age filter cannot be overcome or eliminated unless the user has the passcode (for example, to render the application child-safe). Finally, the clear button 6136 can be used to clear any previously set age filters. For example, a parent may clear the age filters when the device is retrieved from a child.

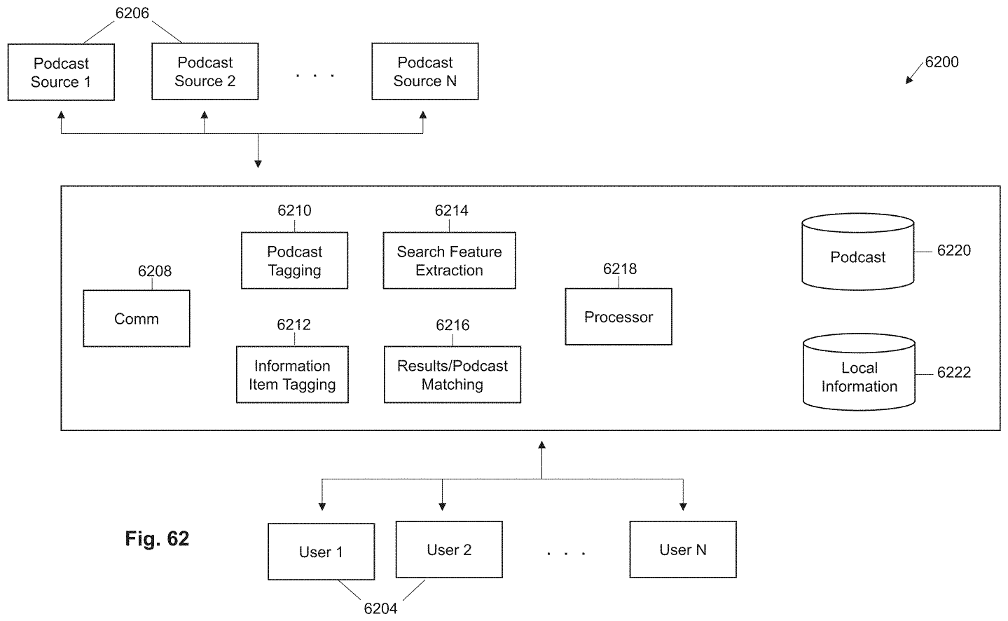

FIG. 62 shows a system 6204 implementing the functionality described above for accessing relevant streaming information such as podcast information. Although the system 6200 will be described in the context of accessing relevant podcast information, it will be appreciated that the system 6200 may be utilized access other types of streaming information such as video information. The system 6200 includes a network platform 6202 that can be employed by users 6204 to access podcasts of podcast sources 6206. The platform 6202 may be a network platform such as a platform of a LAN or a WAN, such as the Internet. In one implementation, the platform 6202 is a cloud-based platform implemented on one or more machines, e.g., servers, at a single location or geographically distributed. In this regard, when the platform 6202 is implemented on multiple machines, the various modules of the platform 6202 may all be replicated on each machine or one or more of the modules may be shared between multiple machines.

The illustrated platform 6202 includes a communications module 6208 for communicating with the podcasts sources 6206, the users 6204, and other resources such as computers of system operators, computers of local providers of goods and services or agents thereof, and other external information sources. In this regard, the module 6208 is operative to receive incoming messages, extract fields of information from the incoming messages, reformat incoming messages, supply missing information as needed, and the like. In addition, the module 6208 is operative to compile information for outgoing messages, format outgoing messages, transmit outgoing messages, and the like. In this regard, the communications module 6208 may communicate with the podcast sources 6206 and users 6204 via an API defining message formats, content, fields, and the like. For example, the module 6208 may receive podcasts from the sources 6206 as well as information describing the podcast content such as metadata or textual descriptive information. In addition, the module 6208 may receive a variety of user inputs from the users 6204 such as search inputs, user information such as demographics and interests, and location information, among other things.

The platform 6200 further includes a podcast tagging module 6210. In this regard, the module 6210 may identify various segments of a podcast and apply tags to the sections to identify or describe the content of the segments. It will be appreciated that many podcasts are long in duration, for example, 30 minutes or longer. In some cases, these podcasts cover a range of topics and only a portion of the podcasts may be of interest to a user. Accordingly, it is useful to identify segments of the podcasts and tag the segments to identify or describe the content of the segments. This may be performed manually or automatically. In the case of manual implementations, an operator may listen to a podcast, identify the starting and ending points of individual segments, and associate descriptors with the individual segments. The descriptors may be based on a data model or schema of the system 6200. For example, in the case of a local information system, the schema may include categories and subcategories of goods and services as well as lists of terms or topics related to those categories and subcategories. The podcasts may be tagged by associating metadata with the segments based on the schema. Any given segment may be associated with one or multiple descriptors. The module 6210 may then be operative to receive information from an operator concerning the segments and segment contents and to associate metadata (e.g., to index fields, attributes, and values) with the segments as stored in a podcast database 6220. In the case of automated implementations, the same schema may be utilized but the analysis of the podcasts is automated, e.g., using textual analysis to identify the beginnings and ends of segments as well as the content of the various segments.

The information item tagging module 6212 executes similar functionality in relation to information items. In the context of a local information services application, the information items may describe local sources of goods and services as well as various fields of information concerning the services as described above. The items of information may be tagged based on categories and subcategories of goods and services as well as associated fields of information such as type of cuisine, hours of operation, etc. The same or different schemas may be used in connection with the tagging of modules 6210 and 6212 although using the same schema will have efficiency advantages. If different schema are utilized, logic may be employed to correlate or associate elements of the different schema.

The search feature extraction module 6214 is operative to extract information from a search input to identify responsive information. For example, in the case of free-form search queries, this may involve textual analysis to extract fields and values from the search query as well as rules to relate the fields and values to search logic. In the case of a local information system as described above, a search query may involve selection of a category and subcategory of goods or services as well as filter settings. In such cases, metadata may be associated with the selections and settings and used to access a database of local information.

The results/podcast matching module 6216 is operative to identify podcasts based on the search input. In this regard, podcasts may be directly identified based on matching the information of a search query to the tags associated with podcast segments such that any podcasts including relevant segments can be identified. In the case of a local information system as described above, the search input may be initially associated with responsive items of local information such as nightclubs, restaurants, concert venues, etc. The responsive items of local information may then be matched to podcasts including relevant segments based on a comparison of the tags associated with the local information and the tags associated with the podcast segments. Any podcasts including relevant segments may then be identified in a response. It should be noted that, because the podcasts are parsed into segments, a link may be provided to the user 6204 such that, upon selection of the link, playback of the podcasts can be initiated at the segment of interest rather than at the start of the podcast if desired.

The processor 6218 executes the functionality of the various modules of the platform 6202. For example, the processor 6218 may be embodied in one or more servers executing appropriate logic. Among other things, the processor 6218 can access the database 6220 of podcast information and the database 6222 of local information to respond to search inputs. Thus, as described above, the processor 6218 may generate information for a user interface screen that includes items of local information concerning providers of goods and services as well as identifying one or more podcasts including relevant information. Again, the relevant information of the podcasts may relate to the items of local information and/or the search input.

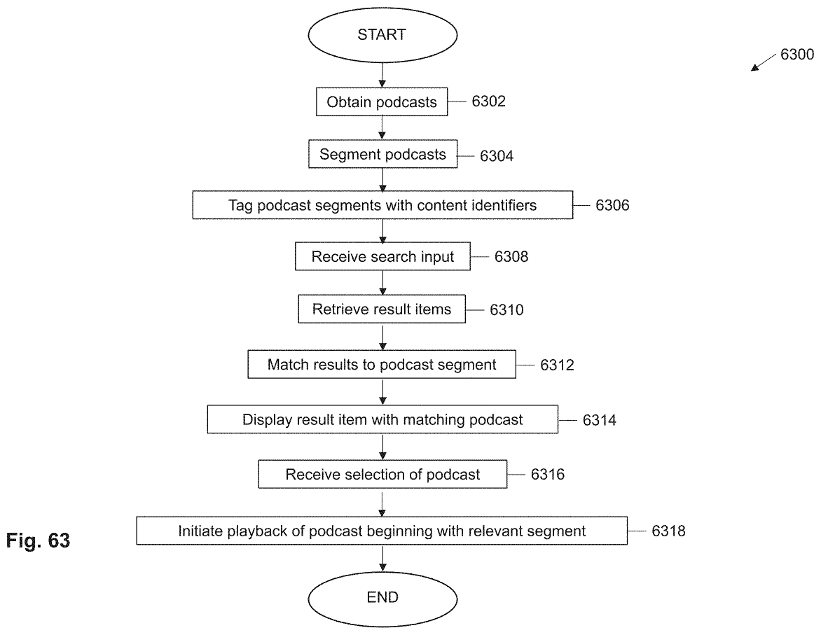

A process 6300 for accessing relevant streaming information may be summarized by reference to the flowchart of FIG. 63. Although the flowchart references podcasts for convenience, it will be appreciated that the functionality is more broadly applicable to a variety of streaming information including audio and/or video information. The illustrated process 6300 is initiated by obtaining (6302) podcasts. For example, the system of the present invention may access various sources of podcasts to upload podcast information to a central platform. Alternatively, the podcasts may reside on platforms of the podcast sources and the central platform may store information describing the podcasts and segments. In either case, the podcasts may be segmented (6304). For example, the podcasts may be analyzed to identify the starting and ending points of various segments as well as to tag the segments to indicate information regarding the content of the segments. The podcast segments may then be tagged (6306) with content identifiers. The content identifiers may be based on a data model or schema and may include information relating to categories and subcategories of goods and services or topics related to such categories and subcategories, among other things.

The illustrated process 6300 further involves receiving (6308) a search input. The search input may be, for example, a free-form search query, a structured search query, a selection of categories and subcategories of local goods and services together with filter settings, or any other data describing information of interest to the user. The search input may be processed to associate the search input with fields, attributes, and values of the search input and/or to associate the search input with contextual information. The processed search input can then be used to retrieve (6310) result items. The result items may be podcasts or podcasts segments. In the case of a local information system as described above, the result items may be data entries corresponding to a local provider of relevant goods and services.

The result items can then be matched (6312) to relevant podcasts segments. For example, the tags associated with the result items may be matched to the tags associated with relevant podcasts segments. Alternatively, logic may be implemented to infer podcast segments that are related to result items. The result items with matching podcasts may then be displayed (6314) to the user. Thus, as described above, a user interface screen may include a result item at the top followed by a list of relevant podcasts. In this regard, the relevant podcasts are identified because they include one or more relevant segments. The system may then receive (6316) a selection of a podcast. For example, in the case of a user interface screen as noted above, the user may select one podcast from the list of podcasts. In response, the system may initiate (6318) playback of the podcast beginning with the relevant segment or from the beginning of the podcast as desired. It will be appreciated that, in many cases, the user may prefer to have playback initiated at the beginning of the relevant segment in order to quickly access the information of interest.

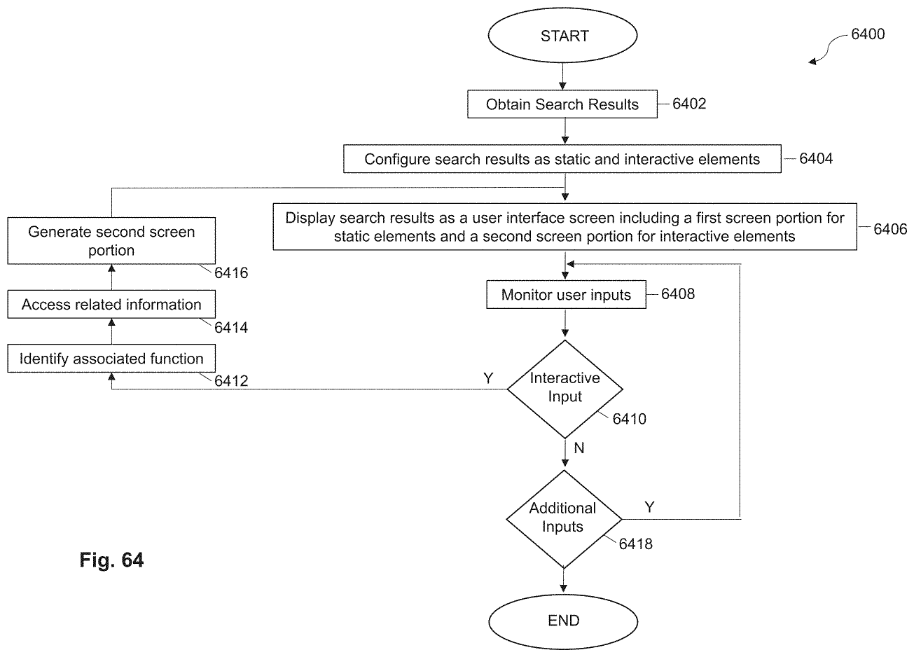

FIG. 64 is a flow chart illustrating a process 6400 for presenting user interface screens with dynamic or interactive elements in accordance with the present invention. Such elements can change while the user navigates through or interacts with a user interface screen. As noted above, such elements may be provided in several contexts. For example, in the context of the interactive calendars noted above, displayed operating hours may change as the user selects different days on the calendar. Similarly, in connection with dynamic look-ahead filters, various information on a user interface screen may change as different filters or combinations of filters are selected.

The illustrated process 6400 is initiated by obtaining (6402) search results. For example, the results may be obtained based on category and sub-category selections in combination with a Near Me filter and/or other filters. The local information system may then configure (6404) the results as static and dynamic elements. In the case of a results page for restaurants, the static elements may relate to, for example, address information, cuisine information, logos and the like. The dynamic information may relate to operating hours information associated with an interactive calendar or banner, among other things. The user interface screen including the static and dynamic elements are then displayed (6406). In this regard, to execute the dynamic elements, portions of the screen or text may be designated as prompts that link to other information or invoke defined functionality. Thus, when the user rolls over those portions or selects those elements, the content of those portions or other portions of the screen may change while the static portions of the screen remain unchanged.

In use, the system then monitors (6408) user inputs such as rolling over or selecting an interactive or dynamic element. If the user provides (6410) an interactive input, the system can identify (6412) the associated function and access (6414) related information. The system can then generate (6416) the content for the second screen portion associated with the dynamic element and populate the second screen portion with that content. For example, if the user selects Saturday on a dynamic calendar, the system may access operating hour information for that day. Similarly, if the user selects a dynamic look-ahead filter icon, the system may look ahead to determine the number of results for the combination of the selected filter or filters and the potential selection of additional filters. The number of potential results may then be displayed in connection with icons for each of the potential filters. This can be repeated for additional inputs (6418).

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1.-58. (canceled)

59. A method for providing access to information about local goods and services, comprising:
establishing a data collection of local information concerning sources of goods and services within a defined geography;
defining a number of categories for grouping subsets of said local information based on defined types of goods and services;
structuring said data collection to enable access to each of said subsets of said local information based on identification of one or more of said categories;
establishing a network-based tool for allowing a first user to search the data collection and receive results identifying at least a first matching source of goods or services;
obtaining streaming content from one or more streaming content sources;
segmenting said streaming content into content segments;
tagging one or more content segments of first streaming content with content identifiers, wherein at least a first content identifier of said content identifiers associates at least a first content segment of said content segments with said first matching source;
providing information concerning said first streaming content in connection with said results;
receiving a selection from said first user regarding said first streaming content; and
based on said selection, initiating playback of said first streaming content beginning at said first content segment.

60. The method of claim 59, further comprising generating a results interface screen by identifying said first matching source responsive to said search input, matching said first content segment to said first matching source and providing, on said results interface screen a first identifier concerning said matching source and a second identifier concerning said first streaming content.

61. The method of claim 59, wherein said first matching source comprises a first provider of goods or services proximate to a location associated with said first user and said first content segment concerns said first provider.

62. The method of claim 61, further comprising obtaining a device location of a user device of said first user and comparing said device location with source locations of said sources of goods and services.

63. The method of claim 59, further comprising, in connection with said network-based tool, providing a first graphical user interface screen including a number of first visual category selectors, each said first visual category selector being configured to allow user selection of a corresponding one of said categories of goods and services and first displaying, in connection with each of said first visual category selectors, an image representing said corresponding one of said categories of goods and services.

64. The method of claim 63, wherein said network-based tool is operative to provide a number of graphical user interface screens wherein a first graphical user interface screen of said graphical user interface screens relates to a sub-category of said local information and said method further comprises displaying, in connection with said first graphical user interface screen, an image representing said subcategory of said local information.

65. The method of claim 59, wherein said results include an interactive calendar having selectors for multiple days, wherein selecting one of the selectors provides information for said first matching source for the corresponding day.

66. The method of claim 59, wherein said results include a link for obtaining directions to said first matching source.

67. The method of claim 59, wherein said results include a link for obtaining a facility map for a facility including said first matching source.

68. The method of claim 59, wherein said results include a link for one of purchasing tickets for an event or making reservations.

69. The method of claim 59, wherein said results include a link for making travel arrangements to said first matching source.

70. A system for providing access to information about local goods and services, comprising:
a network-based platform, comprising:
a data collection of local information concerning sources of goods and services within a defined geography; and
a local information tool operative for:
defining a number of categories for grouping subsets of said local information based on defined types of goods and services;
structuring said data collection to enable access to each of said subsets of said local information based on identification of one or more of said categories;
allowing a first user to search the data collection and receive results identifying at least a first matching source of goods or services;
obtaining streaming content from one or more streaming content sources;
segmenting said streaming content into content segments;
tagging one or more content segments of first streaming content with content identifiers, wherein at least a first content identifier of said content identifiers associates at least a first content segment of said content segments with said first matching source;
providing information concerning said first streaming content in connection with said results;
receiving a selection from said first user regarding said first streaming content; and
based on said selection, initiating playback of said first streaming content beginning at said first content segment.

71. The system of claim 70, wherein said local information tool is further operative for generating a results interface screen by identifying said first matching source responsive to said search input, matching said first content segment to said first matching source and providing, on said results interface screen a first identifier concerning said matching source and a second identifier concerning said first streaming content.

72. The system of claim 70, wherein said first matching source comprises a first provider of goods or services proximate to a location associated with said first user and said first content segment concerns said first provider.

73. The system of claim 72, wherein said local information tool is further operative for obtaining a device location of a user device of said first user and comparing said device location with source locations of said sources of goods and services.

74. The system of claim 70, wherein said local information tool is further operative for providing a first graphical user interface screen including a number of first visual category selectors, each said first visual category selector being configured to allow user selection of a corresponding one of said categories of goods and services and first displaying, in connection with each of said first visual category selectors, an image representing said corresponding one of said categories of goods and services.

75. The system of claim 74, wherein said local information tool is further operative to provide a number of graphical user interface screens wherein a first graphical user interface screen of said graphical user interface screens relates to a sub-category of said local information and said method further comprises displaying, in connection with said first graphical user interface screen, an image representing said subcategory of said local information.

76. The system of claim 70, wherein said results include an interactive calendar having selectors for multiple days, wherein selecting one of the selectors provides information for said first matching source for the corresponding day.

77. The system of claim 70, wherein said results include a link for obtaining directions to said first matching source.

78. The system of claim 70, wherein said results include a link for obtaining a facility map for a facility including said first matching source.

79. The system of claim 70, wherein said results include a link for one of purchasing tickets for an event or making reservations.

80. The system of claim 70, wherein said results include a link for making travel arrangements to said first matching source.
